(19) United States
(12) Patent Application Publication
(10) Pub. No.: US 2026/0057830 A1
(43) Pub. Date: Feb. 26, 2026

(54) DISPLAY DEVICE, ELECTRONIC APPARATUS, AND DRIVING METHOD OF DISPLAY DEVICE

(71) Applicant: SONY SEMICONDUCTOR SOLUTIONS CORPORATION, KANAGAWA (JP)

(72) Inventor: SHUSEI INABA, KANAGAWA (JP)

(21) Appl. No.: 19/105,368

(22) PCT Filed: Aug. 15, 2023
(86) PCT No.: PCT/JP2023/029502

§ 371 Date: Feb. 21, 2025

(30) Foreign Application Priority Data
Aug. 30, 2022 (JP) 2022-137207

(51) Int. Cl. G09G 3/3233; G09G 3/20

(52) U.S. Cl. CPC G09G 3/3233; G09G 3/2074; G09G 2300/0819; G09G 2300/0852; G09G 2310/06; G09G 2310/08; G09G 2320/0233

(57) ABSTRACT

A display device according to an aspect of the present disclosure includes a plurality of pixels and a drive unit, in which each of the plurality of pixels includes a light emitting element, a capacitor, a write transistor that causes a voltage corresponding to a pixel signal to be accumulated in the capacitor, a drive transistor that supplies a current corresponding to the voltage accumulated in the capacitor to the light emitting element, a light emission control transistor that controls whether or not to supply the current from the drive transistor to the light emitting element, and an initialization transistor in which one of a source node and a drain node is provided to be connectable to an anode of the light emitting element and the other is provided to be connectable to a cathode of the light emitting element, and the drive unit turns off the initialization transistors provided in all of the plurality of pixels at or before a timing at which the light emission control transistors provided in pixels that simultaneously emit light among the plurality of pixels are turned on.

### FIELD

The present disclosure relates to a display device, an electronic apparatus, and a driving method of a display device.

### BACKGROUND

As to display devices in recent years, a flat type (flat-panel type) display device has been the mainstream. As one of the flat type display devices, there is a display device using, as a light emitting element of a pixel, a so-called current drive type electro-optical element in which light emission luminance changes according to a current value flowing through a device. As the current drive type electro-optical element, an organic EL element using a phenomenon of emitting light when an electric field is applied to an organic thin film using electro luminescence (EL) of an organic material can be exemplified.

In such a flat type display device, line sequential drive (for example, rolling light emission drive) in which light emission drive is sequentially performed for each horizontal line (each pixel row) is usually used. In the case of the line sequential drive, since the light emission drive is sequentially performed for each horizontal line, the drive timing of the last scanning line is delayed from the drive timing of the first scanning line by a period corresponding to one frame, so that moving image blur may occur.

This moving image blur can be eliminated by using surface collective drive (for example, global light emission drive) in which light emission drive is performed simultaneously for all lines instead of rolling light emission drive. The surface collective drive refers to drive in which signal potentials in all lines (all rows) are written and then a light emission operation is collectively performed on the entire surface. In this surface collective drive, there is a concern about power drop due to the collective light emission operation. As a countermeasure against this problem, a technique has been proposed in which the entire surface is divided into several stages, and the light emission operation is performed with a timing shifted for each stage (see, for example, Patent Literature 1).

In addition, a pixel circuit of a display device usually includes a light emitting element and an initialization transistor that restricts driving (light emission) of the light emitting element. Examples of the pixel circuit include a pixel circuit in which a source of the initialization transistor is connected to an initialization power supply (Vssp) and a cathode of the light emitting element is connected to another power supply (Vcath). On the other hand, there is also a pixel circuit with a common power supply in which the source of the initialization transistor and the cathode of the light emitting element are connected to the common power supply.

### CITATION LIST

### Patent Literature

Patent Literature 1: JP 2022-041374 A

### SUMMARY

### Technical Problem

However, in a case where the light emission operation is performed with the timing shifted for each stage in the pixel circuit with the common power supply as described above, the holding potential of an anode of the light emitting element is different in each stage in the current timing configuration, and for example, there is a difference in coupling (gate-anode coupling) between a gate of a drive transistor connected to the light emitting element and the anode of the light emitting element in each stage, which causes a luminance difference. Therefore, image quality defects (for example, a horizontal band, shading, and the like) occur.

Therefore, the present disclosure provides a display device, an electronic apparatus, and a driving method of a display device capable of improving image quality.

### Solution to Problem

A display device according to an aspect of the present disclosure includes a plurality of signal lines extending along a first direction; a plurality of control lines extending along a second direction different from the first direction; a plurality of pixels; and a drive unit that drives the plurality of pixels, wherein each of the plurality of pixels includes a light emitting element, a capacitor, a write transistor that causes a voltage corresponding to a pixel signal supplied from a corresponding signal line among the plurality of signal lines to be accumulated in the capacitor, a drive transistor that supplies a current corresponding to the voltage accumulated in the capacitor to the light emitting element, a light emission control transistor that controls whether or not to supply the current corresponding to the voltage accumulated in the capacitor from the drive transistor to the light emitting element, and an initialization transistor in which one of a source node and a drain node is provided to be connectable to an anode of the light emitting element and the other of the source node and the drain node is provided to be connectable to a cathode of the light emitting element, and the drive unit turns off the initialization transistors provided in all of the plurality of pixels at or before a timing at which the light emission control transistors provided in pixels that simultaneously emit light among the plurality of pixels are turned on.

An electronic apparatus according to an aspect of the present disclosure includes a display device, wherein the display device includes a plurality of signal lines extending along a first direction, a plurality of control lines extending along a second direction different from the first direction, a plurality of pixels, and a drive unit that drives the plurality of pixels, each of the plurality of pixels includes a light emitting element, a capacitor, a write transistor that causes a voltage corresponding to a pixel signal supplied from a corresponding signal line among the plurality of signal lines to be accumulated in the capacitor, a drive transistor that supplies a current corresponding to the voltage accumulated in the capacitor to the light emitting element, a light emission control transistor that controls whether or not to supply the current corresponding to the voltage accumulated in the capacitor from the drive transistor to the light emitting element, and an initialization transistor in which one of a source node and a drain node is provided to be connectable to an anode of the light emitting element and the other of the source node and the drain node is provided to be connectable to a cathode of the light emitting element, and the drive unit turns off the initialization transistors provided in all of the plurality of pixels at or before a timing at which the light emission control transistors provided in pixels that simultaneously emit light among the plurality of pixels are turned on.

A driving method of a display device according to an aspect of the present disclosure, the display device includes a plurality of signal lines extending along a first direction, a plurality of control lines extending along a second direction different from the first direction, a plurality of pixels, and a drive unit that drives the plurality of pixels, each of the plurality of pixels includes a light emitting element, a capacitor, a write transistor that causes a voltage corresponding to a pixel signal supplied from a corresponding signal line among the plurality of signal lines to be accumulated in the capacitor, a drive transistor that supplies a current corresponding to the voltage accumulated in the capacitor to the light emitting element, a light emission control transistor that controls whether or not to supply the current corresponding to the voltage accumulated in the capacitor from the drive transistor to the light emitting element, and an initialization transistor in which one of a source node and a drain node is provided to be connectable to an anode of the light emitting element and the other of the source node and the drain node is provided to be connectable to a cathode of the light emitting element, the driving method includes turning off, by the drive unit, the initialization transistors provided in all of the plurality of pixels at or before a timing at which the light emission control transistors provided in pixels that simultaneously emit light among the plurality of pixels are turned on.

### BRIEF DESCRIPTION OF DRAWINGS

FIG. 1 is a diagram illustrating a configuration example of a display device according to an embodiment of the present disclosure.

FIG. 2 is a diagram illustrating a configuration example of a pixel according to the embodiment of the present disclosure.

FIG. 3 is a diagram illustrating timing waveforms of a basic circuit operation according to the embodiment of the present disclosure.

FIG. 4 is a diagram for explaining surface collective drive according to the embodiment of the present disclosure.

FIG. 5 is a diagram illustrating timing waveforms of surface collective drive of a comparative example according to the embodiment of the present disclosure.

FIG. 6 is a diagram for explaining potential changes of a drive transistor and a light emitting element by the surface collective drive of the comparative example according to the embodiment of the present disclosure.

FIG. 7 is a diagram illustrating non-uniform luminance of a pixel array unit of the comparative example according to the embodiment of the present disclosure.

FIG. 8 is a diagram illustrating timing waveforms of surface collective drive of Specific Example 1 according to the embodiment of the present disclosure.

FIG. 9 is a diagram for explaining potential changes of a drive transistor and a light emitting element by the surface collective drive of Specific Example 1 according to the embodiment of the present disclosure.

FIG. 10 is a diagram illustrating uniform luminance of the pixel array unit of Specific Example 1 according to the embodiment of the present disclosure.

FIG. 11 is a diagram illustrating timing waveforms of surface collective drive of Specific Example 2 according to the embodiment of the present disclosure.

FIG. 12 is a diagram illustrating another configuration example of the pixel.

FIG. 13 is a diagram illustrating another configuration example of the pixel.

FIG. 14 is a diagram illustrating another configuration example of the pixel.

FIG. 15 is a diagram illustrating another configuration example of the pixel.

FIG. 16 is a diagram illustrating another configuration example of the pixel.

FIG. 17 is a diagram illustrating another configuration example of the pixel.

FIG. 18 is a diagram illustrating another configuration example of the pixel.

FIG. 19 is a diagram illustrating an example of an appearance of a smartphone.

FIG. 20 is a diagram illustrating an example of an appearance of a digital still camera.

FIG. 21 is a diagram illustrating an example of the appearance of the digital still camera.

FIG. 22 is a diagram illustrating an example of an appearance of a head mounted display.

FIG. 23 is a diagram illustrating an example of an appearance of a see-through head mounted display.

FIG. 24 is a diagram illustrating an example of an appearance of a television device.

FIG. 25 is a diagram illustrating an internal configuration of a vehicle.

FIG. 26 is a diagram illustrating the internal configuration of the vehicle.

### DESCRIPTION OF EMBODIMENTS

Hereinafter, embodiments of the present disclosure will be described in detail with reference to the drawings. Note that a device, an apparatus, a method, and the like according to the present disclosure are not limited by the embodiments. In addition, in the following embodiments, basically the same parts are denoted by the same reference numerals, and redundant description is omitted.

One or a plurality of embodiments (including examples and modifications) described below can each be implemented independently. On the other hand, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

The present disclosure will be described according to the following order of items.
1. Embodiments
1-1. Configuration Example of Display Device
1-2. Configuration Example of Pixel
1-3. Basic Circuit Operation
1-4. Surface Collective Drive
1-5. Actions and Effects
2. Other Embodiments
3. Modifications
4. Application Examples
5. Appendix

### 1. Embodiments

### 1-1. Configuration Example of Display Device

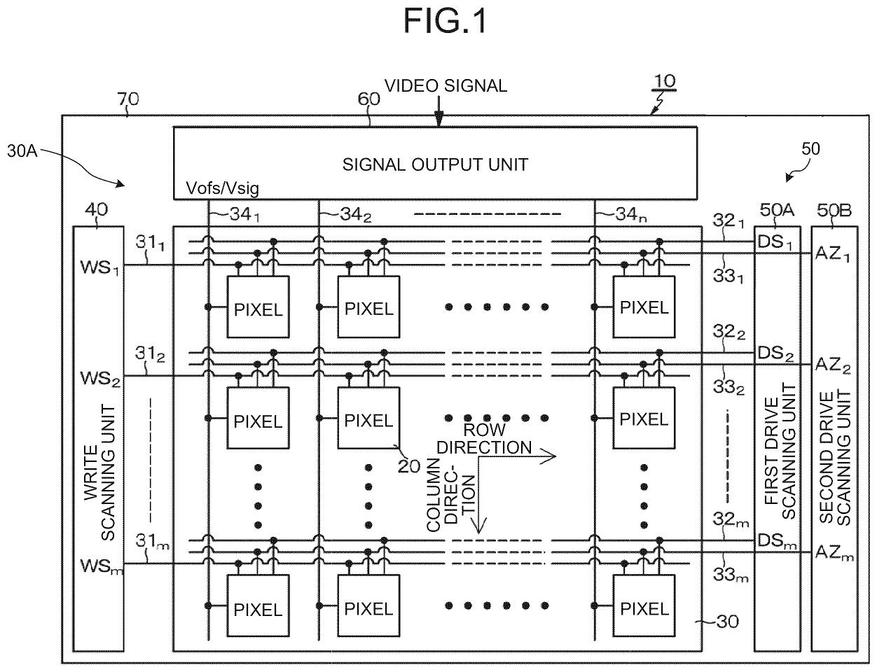

A configuration example of a display device 10 according to an embodiment will be described with reference to FIG. 1. FIG. 1 is a diagram illustrating the configuration example of the display device 10 according to the present embodiment.

The display device 10 according to the present embodiment is, for example, an active matrix-type display device that controls a current flowing through an electro-optical element by an active element (for example, an insulated gate field effect transistor) provided in a pixel including the electro-optical element. Note that examples of the insulated gate field effect transistor include a metal oxide semiconductor (MOS) transistor and a thin film transistor (TFT). Here, for example, an organic EL display device using an organic EL element as a light emitting element of a pixel will be described as an example of a current drive type electro-optical element in which light emission luminance changes according to a current value flowing through a device.

As illustrated in FIG. 1, the display device 10 according to the present embodiment includes a pixel array unit 30 in which a plurality of pixels 20 are two-dimensionally arranged in a matrix, and a peripheral circuit unit 30A arranged around the pixel array unit 30.

The peripheral circuit unit 30A includes, for example, a write scanning unit 40, a drive scanning unit 50 (a first drive scanning unit 50A and a second drive scanning unit 50B), and a signal output unit 60. A part or all of the peripheral circuit unit 30A corresponds to a drive unit that drives each pixel 20 of the pixel array unit 30.

The write scanning unit 40, the first drive scanning unit 50A, the second drive scanning unit 50B, and the signal output unit 60 are mounted, for example, on the same display panel 70 as the pixel array unit 30. However, it is also possible to adopt a configuration in which some or all of the write scanning unit 40, the first drive scanning unit 50A, the second drive scanning unit 50B, and the signal output unit 60 are provided outside the display panel 70.

In addition, the display device 10 can be configured to support monochrome (black-and-white) display, or can be configured to support color display. In a case where the display device 10 supports color display, one pixel (unit pixel) serving as a unit for forming a color image includes a plurality of subpixels. At this time, each of the subpixels corresponds to the pixel 20 in FIG. 1. More specifically, in a display device that supports color display, one pixel includes, for example, three subpixels: a subpixel that emits red (R) light; a subpixel that emits green (G) light; and a subpixel that emits blue (B) light.

However, one pixel is not limited to a combination of subpixels of three primary colors of RGB, and one pixel can be configured by further adding a subpixel of one color or subpixels of a plurality of colors to the subpixels of three primary colors. More specifically, for example, one pixel can be configured by adding a subpixel that emits white (W) light in order to improve luminance, or one pixel can be configured by adding at least one subpixel that emits complementary color light in order to expand a color reproduction range.

In the pixel array unit 30, a scanning line 31 (31₁ to 31ₘ), a first drive line 32 (32₁ to 32ₘ), and a second drive line 33 (33₁ to 33ₘ) extending along a row direction (array direction of pixels of a pixel row) are wired for each pixel row with respect to an array of the pixels 20 of m rows and n columns. Furthermore, a signal line 34 (34₁ to 34ₙ) extending along a column direction (array direction of pixels of a pixel column) is wired for each pixel column with respect to the array of the pixels 20 of m rows and n columns. Each of the scanning line 31, the first drive line 32, and the second drive line 33 corresponds to a control line.

Each scanning line 31 (31₁ to 31ₘ) is connected to an output end of a corresponding row of the write scanning unit 40. Each first drive line 32 (32₁ to 32ₘ) is connected to an output end of a corresponding row of the first drive scanning unit 50A. Each second drive line 33 (33₁ to 33ₘ) is connected to an output end of a corresponding row of the second drive scanning unit 50B. Each signal line 34 (34₁ to 34ₙ) is connected to an output end of a corresponding column of the signal output unit 60.

The write scanning unit 40 includes a shift register circuit and the like. When writing a signal voltage of a video signal to each pixel 20 of the pixel array unit 30, the write scanning unit 40 sequentially supplies a write scanning signal WS (WS₁ to WSₘ) to the scanning line 31 (31₁ to 31ₘ) to sequentially scan each pixel 20 of the pixel array unit 30 row by row, that is, perform line sequential scanning. Note that the video signal is an example of a data signal (information signal).

Similarly to the write scanning unit 40, the first drive scanning unit 50A includes a shift register circuit and the like. The first drive scanning unit 50A supplies a light emission control signal DS (DS₁ to DSₘ) to the first drive line 32 (32₁ to 32ₘ), for example, in synchronization with the line sequential scanning by the write scanning unit 40 to control light emission/non-light emission (extinction) of the pixel 20.

Similarly to the write scanning unit 40, the second drive scanning unit 50B includes a shift register circuit and the like. The second drive scanning unit 50B supplies an auto-zero signal AZ (AZ₁ to AZₘ) to the second drive line 33 (33₁ to 33ₘ), for example, in synchronization with the line sequential scanning by the write scanning unit 40 to control the pixel 20 not to emit light in a non-light emission period.

The signal output unit 60 alternatively outputs, to the signal line 34 (34₁ to 34ₙ), a signal voltage (hereinafter simply described as “signal voltage” in some cases) Vsig of a video signal according to luminance information supplied from an external signal supply source (not illustrated), and an initialization voltage Vofs for initializing a gate voltage of a drive transistor Tr1 described later.

The signal voltage Vsig/initialization voltage Vofs alternatively output from the signal output unit 60 is written to each pixel 20 of the pixel array unit 30 via the signal line 34 (34₁ to 34ₙ) in units of pixel rows selected by line sequential scanning by the write scanning unit 40. That is, the signal output unit 60 adopts a line sequential write drive mode in which the signal voltage Vsig is written in units of pixel rows (lines).

Note that the initialization voltage Vofs may be set to a fixed voltage, for example, a voltage corresponding to a black level of the video signal or a voltage in the vicinity thereof. On the other hand, the initialization voltage Vofs may be variable, and for example, the signal output unit 60 may be configured to change the initialization voltage Vofs according to the signal voltage Vsig of the video signal for each pixel to which the signal voltage Vsig of the video signal is written.

### 1-2. Configuration Example of Pixel

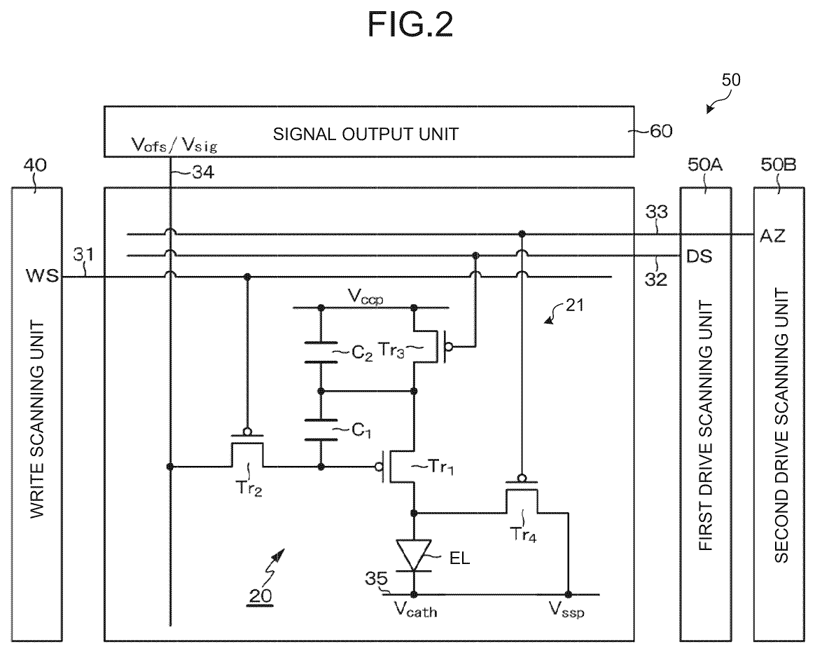

A configuration example of the pixel 20 according to the present embodiment will be described with reference to FIG. 2. FIG. 2 is a diagram illustrating a configuration example of the pixel 20 according to the present embodiment.

As illustrated in FIG. 2, the pixel 20 includes a light emitting element EL and a drive circuit unit 21 that drives the light emitting element EL by causing a current to flow through the light emitting element EL.

The light emitting element EL is, for example, an organic EL element, and a cathode electrode is connected to a common power supply line 35 wired in common for all the pixels 20. The drive circuit unit 21 has a configuration of 4Tr (transistor)/2C (capacitive element) including the drive transistor Tr1, a write transistor (sampling transistor) Tr2, a light emission control transistor Tr3, an initialization transistor Tr4, a holding capacitor C1, and an auxiliary capacitor C2.

Note that in the present example, the pixel 20 is formed not on an insulator such as a glass substrate but on a semiconductor substrate such as a silicon substrate. The drive transistor Tr1 includes a P-channel transistor. In addition, in the present example, the write transistor Tr2, the light emission control transistor Tr3, and the initialization transistor Tr4 also adopt a configuration using a P-channel transistor similarly to the drive transistor Tr1. For example, the drive transistor Tr1, the write transistor Tr2, the light emission control transistor Tr3, and the initialization transistor Tr4 have a four-terminal configuration of source/gate/drain/back gate, instead of a three-terminal configuration of source/gate/drain.

However, the write transistor Tr2, the light emission control transistor Tr3, and the initialization transistor Tr4 are switching transistors that function as switching elements (switch elements), and thus are not limited to P-channel transistors. Therefore, the write transistor Tr2, the light emission control transistor Tr3, and the initialization transistor Tr4 may be N-channel transistors or may have a configuration in which a P-channel transistor and an N-channel transistor are mixed.

A drain electrode of the drive transistor Tr1 is connected to an anode (anode electrode) of the light emitting element EL. That is, the drive transistor Tr1 is connected in series to the light emitting element EL, and drives the light emitting element EL according to the signal voltage Vsig of the video signal supplied from the signal output unit 60 through the signal line 34.

The write transistor Tr2 is connected between the signal line 34 and a gate (gate electrode) of the drive transistor Tr1. The write transistor Tr2 samples the signal voltage Vsig/initialization voltage Vofs of the video signal supplied from the signal output unit 60 through the signal line 34 to write the signal voltage Vsig/initialization voltage Vofs to the gate of the drive transistor Tr1. A gate voltage Vg of the drive transistor Tr1 is initialized by writing the initialization voltage Vofs.

The light emission control transistor Tr3 is connected between a power supply line of a high-potential-side power supply voltage Vccp and a source (source electrode) of the drive transistor Tr1. The light emission control transistor Tr3 controls light emission/non-light emission of the light emitting element EL under driving by the light emission control signal DS applied to a gate (gate electrode) from the first drive scanning unit 50A through the first drive line 32.

The initialization transistor Tr4 is connected between a drain (drain electrode) of the drive transistor Tr1 and a current discharge destination node (for example, a power supply line of a low-potential-side power supply voltage Vssp). The initialization transistor Tr4 performs control so that the light emitting element EL does not emit light in the non-light emission period of the light emitting element EL under driving by the auto-zero signal AZ applied to a gate (gate electrode) from the second drive scanning unit 50B through the second drive line 33. That is, the initialization transistor Tr4 is an example of a switching element that restricts driving (light emission) of the light emitting element EL.

Note that the power supply line of the low-potential-side power supply voltage Vssp, which is an example of the current discharge destination node, is connected to the common power supply line 35. That is, the power supply line (power supply line of initialization power supply) of the low potential-side power supply voltage Vssp is connected to a power supply line (Vcath) of the cathode of the light emitting element EL. Therefore, the light emitting element EL and the initialization transistor Tr4 are connected to a common power supply.

The holding capacitor C1 is connected between the gate (gate electrode) and the source (source electrode) of the drive transistor Tr1, and holds the signal voltage Vsig written by sampling by the write transistor Tr2. The drive transistor Tr1 drives the light emitting element EL by causing a drive current corresponding to the holding voltage of the holding capacitor C1 to flow through the light emitting element EL.

The auxiliary capacitor C2 is connected between the source (source electrode) of the drive transistor Tr1 and a node (for example, the power supply line of the high-potential-side power supply voltage Vccp) of a fixed potential. The auxiliary capacitor C2 has an action of suppressing fluctuation of the source voltage of the drive transistor Tr1 when the signal voltage Vsig of the video signal is written, and an action of setting a voltage Vgs between the gate electrode and the source electrode of the drive transistor Tr1 to a threshold voltage Vth of the drive transistor Tr1.

### 1-3. Basic Circuit Operation

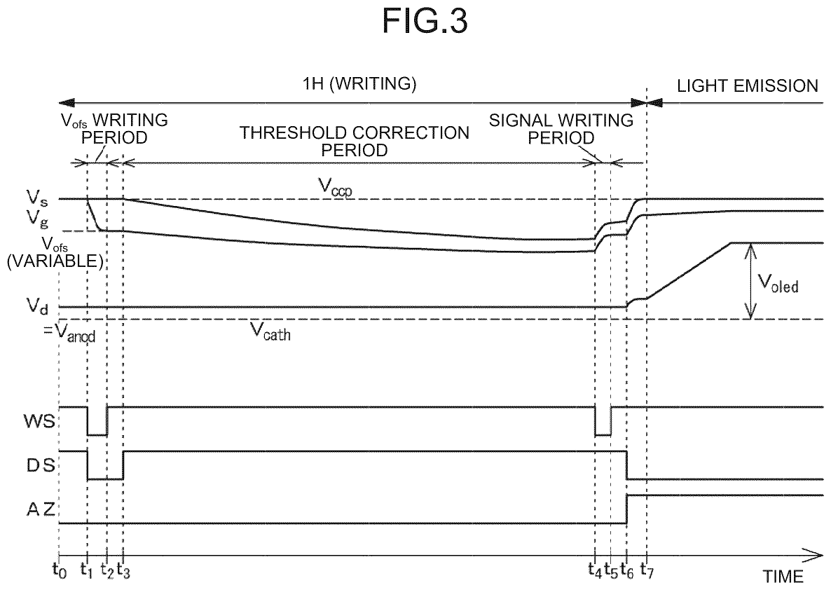

A basic circuit operation according to the present embodiment will be described with reference to FIG. 3. FIG. 3 is a diagram illustrating timing waveforms of the circuit operation according to the present embodiment.

FIG. 3 illustrates how a source voltage Vs, the gate voltage Vg, and a drain voltage Vd (=an anode voltage Vanod of the light emitting element EL) of the drive transistor Tr1, the write scanning signal WS, the light emission control signal DS, and the auto-zero signal AZ change.

Note that since the write transistor Tr2, the light emission control transistor Tr3, and the initialization transistor Tr4 are P-channel transistors, a low level state of the write scanning signal WS, the light emission control signal DS, and the auto-zero signal AZ is an active state, and a high level state is an inactive state. Then, the write transistor Tr2, the light emission control transistor Tr3, and the initialization transistor Tr4 are brought into a conductive state (ON) in the active state of the write scanning signal WS, the light emission control signal DS, and the auto-zero signal AZ, and are brought into a non-conductive state (OFF) in the inactive state.

At time t1, the write scanning signal WS transitions from a high level to a low level, so that the write transistor Tr2 is brought into the conductive state. At this time, the initialization voltage Vofs for initializing the gate voltage of the drive transistor Tr1 is output from the signal output unit 60 to the signal line 34. Therefore, the initialization voltage Vofs is written to the gate electrode of the drive transistor Tr1 by sampling by the write transistor Tr2, and the gate voltage Vg of the drive transistor Tr1 is initialized to Vofs.

In addition, at time t1, since the light emission control signal DS also transitions from the high level to the low level, the light emission control transistor Tr3 is brought into the conductive state. Therefore, the source voltage Vs of the drive transistor Tr1 becomes the power supply voltage Vccp. At this time, the voltage (hereinafter described as “gate-source voltage Vgs” in some cases) between the gate electrode and the source electrode of the drive transistor Tr1 is Vgs=Vofs−Vccp.

Here, in order to execute a threshold correction operation (threshold correction processing) for correcting the variation of the threshold voltage Vth of the drive transistor Tr1 for each pixel 20, it is preferable to set the gate-source voltage Vgs of the drive transistor Tr1 to a predetermined voltage value.

As described above, an initialization operation for setting (initializing) the gate voltage Vg of the drive transistor Tr1 to the initialization voltage Vofs and setting the source voltage Vs of the drive transistor Tr1 to the power supply voltage Vccp is an operation for preparation (threshold correction preparation) before the next threshold correction operation is performed. Therefore, the initialization voltage Vofs and the power supply voltage Vccp are the initialization voltages of the gate voltage Vg and the source voltage Vs of the drive transistor Tr1, respectively.

Next, at time t2, the write scanning signal WS transitions from the low level to the high level, and the write transistor Tr2 is brought into the non-conductive state, so that the writing of the initialization voltage Vofs ends. Next, at time t3, when the light emission control signal DS transitions from the low level to the high level and the light emission control transistor Tr3 is brought into the non-conductive state, the threshold correction operation is started in a state where the source electrode of the drive transistor Tr1 is brought into a floating state and the gate voltage Vg of the drive transistor Tr1 is maintained at the initialization voltage Vofs. That is, the source voltage Vs of the drive transistor Tr1 starts to fall (decrease) toward a voltage (Vg−Vth) obtained by subtracting the threshold voltage Vth from the gate voltage Vg of the drive transistor Tr1.

Here, the initialization voltage Vofs output from the signal output unit 60 to the signal line 34 and written to the gate electrode of the drive transistor Tr1 via the write transistor Tr2 is variable according to the signal voltage Vsig of the video signal. Then, an operation for changing the source voltage Vs of the drive transistor Tr1 toward the voltage (Vg−Vth) obtained by subtracting the threshold voltage Vth of the drive transistor Tr1 from the initialization voltage Vofs with reference to the initialization voltage Vofs of the gate voltage Vg of the drive transistor Tr1 is the threshold correction operation. That is, the display device 10 according to the present embodiment has a threshold correction function of correcting the variation of the threshold voltage Vth of the drive transistor Tr1 for each pixel 20.

As the threshold correction operation described above proceeds, the gate-source voltage Vgs of the drive transistor Tr1 eventually converges to the threshold voltage Vth of the drive transistor Tr1. A voltage corresponding to the threshold voltage Vth is held in the holding capacitor C1.

At time t4, the write scanning signal WS transitions again from the high level to the low level, and the write transistor Tr2 is brought into the conductive state. At this time, the signal voltage Vsig of the video signal is output from the signal output unit 60 to the signal line 34 instead of the initialization voltage Vofs. Then, the signal voltage Vsig of the video signal is written into the pixel 20 by the write transistor Tr2. By the writing operation of the signal voltage Vsig by the write transistor Tr2, the gate voltage Vg of the drive transistor Tr1 becomes the signal voltage Vsig.

In the writing of the signal voltage Vsig of the video signal, the auxiliary capacitor C2 connected between the source electrode of the drive transistor Tr1 and the power supply line of the power supply voltage Vccp has an action of suppressing the fluctuation of the source voltage Vs of the drive transistor Tr1. Then, in the driving of the drive transistor Tr1 by the signal voltage Vsig of the video signal, the threshold voltage Vth of the drive transistor Tr1 is canceled out by the voltage corresponding to the threshold voltage Vth held in the holding capacitor C1.

Next, at time t5, the write scanning signal WS transitions from the low level to the high level, and the write transistor Tr2 is brought into the non-conductive state, so that a writing period of the signal voltage Vsig of the video signal ends. Thereafter, at time t6, the light emission control signal DS transitions from the high level to the low level, so that the light emission control transistor Tr3 is brought into the conductive state. As a result, a current is supplied from the power supply line of the power supply voltage Vccp to the drive transistor Tr1 through the light emission control transistor Tr3.

At this time, since the write transistor Tr2 is in the non-conductive state, the gate electrode of the drive transistor Tr1 is electrically disconnected from the signal line 34 and is in the floating state. Here, when the gate electrode of the drive transistor Tr1 is in the floating state, the gate voltage Vg also fluctuates in conjunction with the fluctuation of the source voltage Vs of the drive transistor Tr1 because the holding capacitor C1 is connected between the gate and the source of the drive transistor Tr1.

As described above, the operation in which the gate voltage Vg of the drive transistor Tr1 fluctuates in conjunction with the fluctuation of the source voltage Vs is a bootstrap operation. In other words, the bootstrap operation is an operation in which the gate voltage Vg and the source voltage Vs of the drive transistor Tr1 fluctuate by the holding capacitor C1.

Then, since a drain-source current Ids of the drive transistor Tr1 starts to flow through the light emitting element EL, the anode voltage Vanod of the light emitting element EL increases according to the current Ids. Eventually, when the anode voltage Vanod of the light emitting element EL exceeds a threshold voltage Vthel of the light emitting element EL (time t7), a drive current starts to flow through the light emitting element EL, so that the light emitting element EL starts to emit light.

On the other hand, the auto-zero signal AZ is in the active state, for example, in a period until time t6 at which the light emission control signal DS transitions from the high level to the low level, and thus the initialization transistor Tr4 is in the conductive state. Then, since the initialization transistor Tr4 is in the conductive state, the drain electrode (anode electrode of the light emitting element EL) of the drive transistor Tr1 and the current discharge destination node (for example, the power supply line of the low-potential-side power supply voltage Vssp) are electrically short-circuited via the initialization transistor Tr4.

Here, an on-resistance of the initialization transistor Tr4 is much smaller than that of the light emitting element EL. Therefore, in the non-light emission period of the light emitting element EL, the current flowing through the drive transistor Tr1 can be forcibly flown into the current discharge destination node, and can be prevented from flowing into the light emitting element EL. Incidentally, the auto-zero signal AZ is in the active state in 1H in which threshold correction and signal writing are performed, but the auto-zero signal is in the inactive state in the subsequent light emission period.

By the action of the initialization transistor Tr4 described above, it is possible to prevent the current flowing through the drive transistor Tr1 from flowing into the light emitting element EL in the non-light emission period of the light emitting element EL. As a result, since it is possible to suppress the light emission of the light emitting element EL in the non-light emission period, the contrast of the display panel 70 can be increased as compared with a pixel configuration without the initialization transistor Tr4.

In the series of basic circuit operations described above, the operations of the threshold correction preparation, the threshold correction, and the writing (signal writing) of the signal voltage Vsig of the video signal are executed, for example, in one horizontal period (1H).

### 1-4. Surface Collective Drive

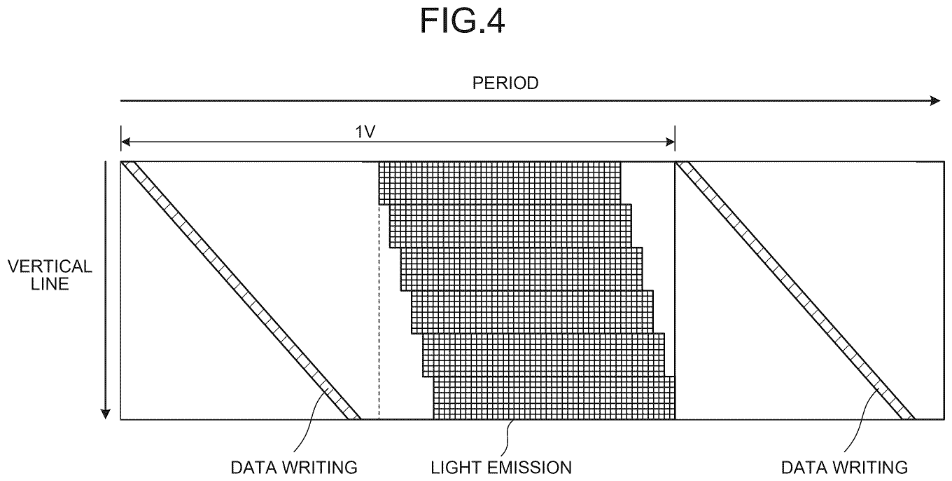

Surface collective drive according to the present embodiment will be described with reference to FIGS. 4 to 11. FIG. 4 is a diagram for explaining the surface collective drive (for example, global light emission drive) according to the present embodiment.

In the surface collective drive according to the present embodiment, the entire surface of the pixel array unit 30 is divided into several stages (a plurality of units), and a light emission operation is performed with a timing shifted for each stage. As a result, it is possible to suppress power drop due to a collective light emission operation in which light emission drive is performed simultaneously for all lines.

As illustrated in FIG. 4, for example, the display device 10 writes a video signal while scanning each pixel 20 of the pixel array unit 30 in units of lines (units of pixel rows) under driving by the write scanning unit 40 (“data writing” in FIG. 4). Furthermore, the display device 10 divides a display screen by the pixels 20 of the pixel array unit 30 into several stages in a scanning direction (for example, the column direction) under driving by the drive scanning unit 50 (the first drive scanning unit 50A and the second drive scanning unit 50B), and performs the light emission operation with the timing shifted for each divided stage (“light emission” in FIG. 4).

Here, the stages are a plurality of predetermined regions (plurality of units) formed by dividing the display screen by the pixels 20 of the pixel array unit 30. The predetermined region is set in advance, for example. In the example of FIG. 4, a region having eight pixel rows is set as the predetermined region, and the predetermined regions are arranged in the column direction. Note that in the example of FIG. 4, the stages (predetermined regions) are formed so as to be arranged in the column direction, that is, the display screen is divided in the column direction, but the present invention is not limited thereto, and the display screen may be divided in the row direction. In addition, the sizes of the stages are the same, but are not limited thereto, and may be different. In addition, not only a plurality of rows/plurality of columns adjacent to each other may be set as one unit (one block) (for example, the 1st to 4th rows or columns are set as one unit, and the 5th to 8th rows or columns are set as one unit), but also an arbitrary plurality of rows/plurality of columns may be set as one unit (for example, the 1st, 3rd, 5th, and 7th rows or columns are set as one unit, and the 2nd, 4th, 6th, and 8th rows or columns are set as one unit).

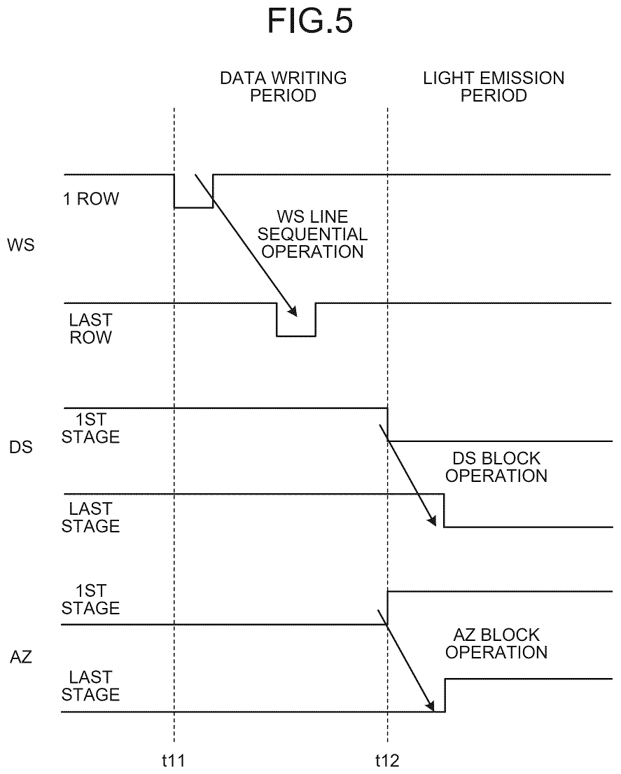

Details of such surface collective drive will be described with reference to FIGS. 5 to 11 with specific examples and a comparative example according to the present embodiment. First, a comparative example will be described, and then Specific Example 1 and Specific Example 2 will be described. Note that in the following description, description of the same parts as those of the basic circuit operation as described above will be omitted.

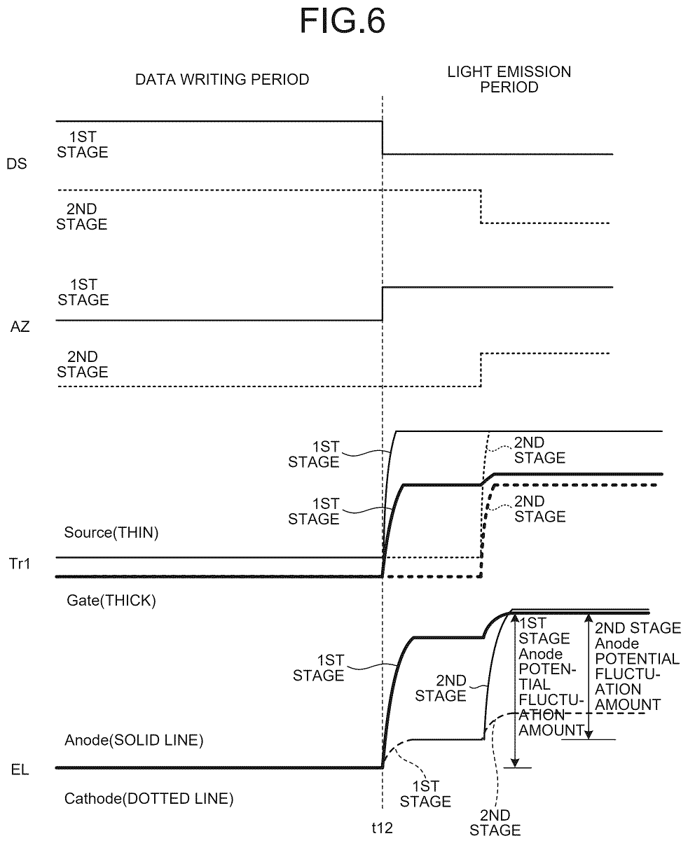

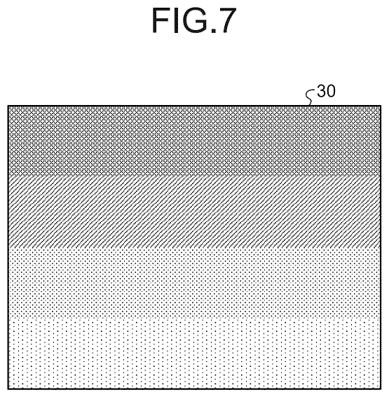

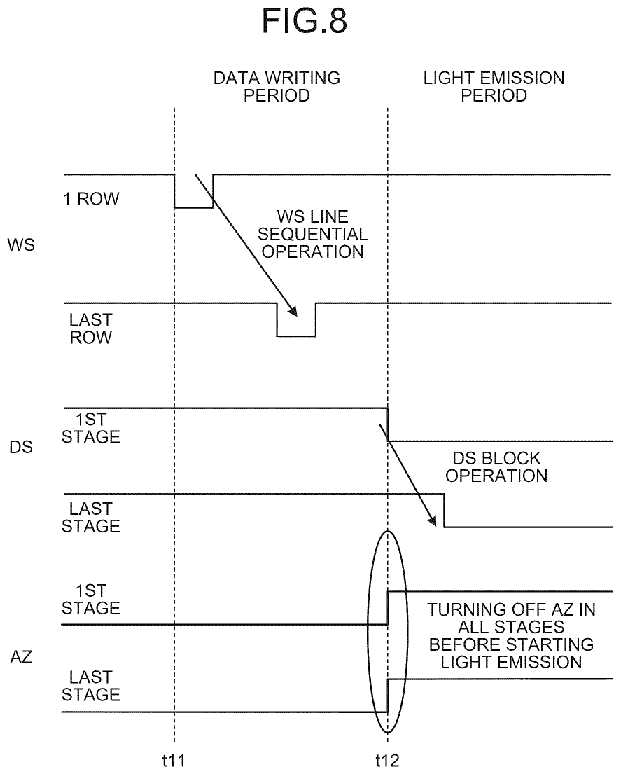

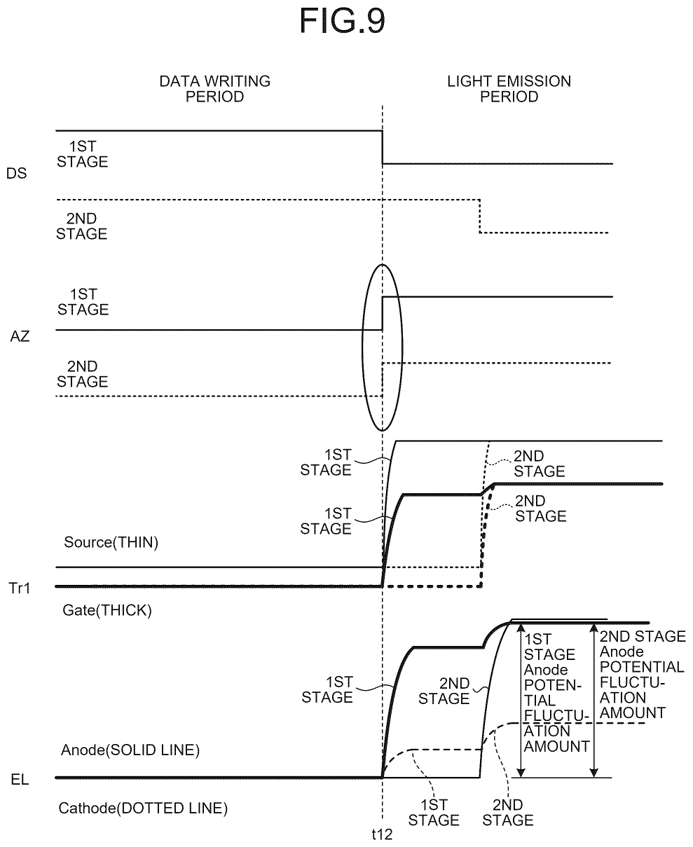

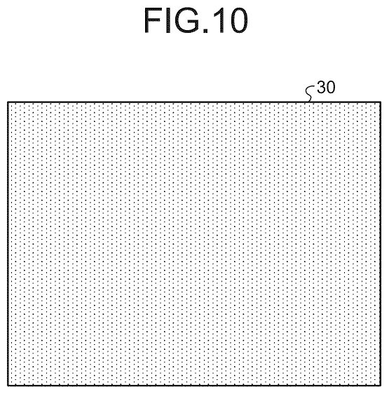

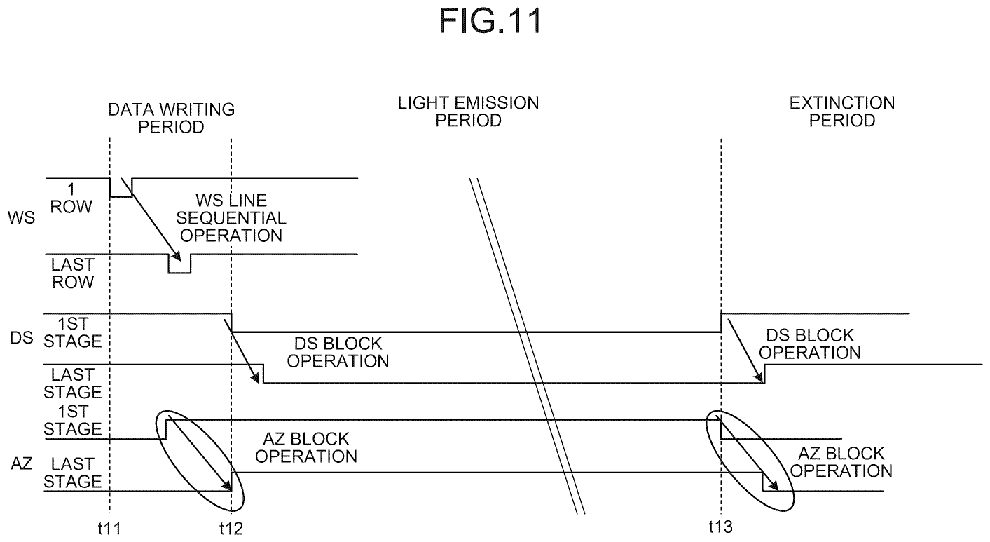

FIG. 5 is a diagram illustrating timing waveforms of surface collective drive of the comparative example. FIG. 6 is a diagram for explaining potential changes of the drive transistor Tr1 and the light emitting element EL by the surface collective drive of the comparative example. FIG. 7 is a diagram illustrating non-uniform luminance (luminance difference) of the pixel array unit 30 of the comparative example. FIG. 8 is a diagram illustrating timing waveforms of surface collective drive of Specific Example 1. FIG. 9 is a diagram for explaining potential changes of the drive transistor Tr1 and the light emitting element EL by the surface collective drive of Specific Example 1. FIG. 10 is a diagram illustrating uniform luminance of the pixel array unit 30 of Specific Example 1. FIG. 11 is a diagram illustrating timing waveforms of surface collective drive of Specific Example 2.

### Comparative Example

In the comparative example, as illustrated in FIG. 5, in the data writing period, the write scanning signal WS sequentially transitions from the high level to the low level for each pixel row from time t11, and after a lapse of a certain period of time, the write scanning signal WS transitions from the low level to the high level. As a result, the write transistor Tr2 is sequentially brought into the conductive state for each pixel row, and after a lapse of a certain period of time, the write transistor Tr2 is brought into a non-energized state (“WS line sequential operation” in the data writing period in FIG. 5). The WS line corresponds to the scanning line 31.

Thereafter, in the light emission period, the light emission control signal DS sequentially transitions from the high level to the low level for each stage from time t12. As a result, the light emission control transistor Tr3 is sequentially brought into the conductive state for each stage (“DS block operation” in the light emission period in FIG. 5).

In addition, in the light emission period, the auto-zero signal AZ sequentially transitions from the low level to the high level for each stage from time t12. As a result, the initialization transistor Tr4 is sequentially brought into the non-conductive state for each stage (“AZ block operation” in the light emission period in FIG. 5).

Note that for example, in a period until the light emission control signal DS transitions from the high level to the low level, the auto-zero signal AZ is in the active state and the initialization transistor Tr4 is in the conductive state. As a result, it is possible to perform control so that the light emitting element EL does not emit light in the non-light emission period of the light emitting element EL.

In such a comparative example, as illustrated in FIG. 6, as the holding potential of the anode of the light emitting element EL (the anode potential held for each stage) is different in each stage, the anode potential fluctuation amount is different in each stage. Therefore, there is a difference in coupling (gate-anode coupling) between the gate of the drive transistor Tr1 and the anode of the light emitting element EL in each stage, and the gate-source voltage Vgs of the drive transistor Tr1 changes for each stage. As a result, as illustrated in FIG. 7, a luminance difference (gray difference in FIG. 7) occurs in the pixel array unit 30. In addition, power drop may occur due to a light emission current. Specific Example 1 and Specific Example 2 described below will be described as means for suppressing the luminance difference, the power drop, and the like.

### Specific Example 1

In Specific Example 1, as illustrated in FIG. 8, in the data writing period, the write scanning signal WS sequentially transitions from the high level to the low level for each pixel row from time t11, and after a lapse of a certain period of time, the write scanning signal WS transitions from the low level to the high level. As a result, the write transistor Tr2 is sequentially brought into the conductive state for each pixel row, and after a lapse of a certain period of time, the write transistor Tr2 is brought into the non-energized state (“WS line sequential operation” in the data writing period in FIG. 8).

Thereafter, in the light emission period, the light emission control signal DS sequentially transitions from the high level to the low level for each stage from time t12. As a result, the light emission control transistor Tr3 is sequentially brought into the conductive state for each stage (“DS block operation” in the light emission period in FIG. 8).

In addition, in the light emission period, the auto-zero signals AZ simultaneously transition from the low level to the high level in all stages from time t12 (“turning OFF AZ in all stages before starting light emission” in the light emission period in FIG. 8). As a result, the initialization transistors Tr4 are simultaneously brought into the non-conductive state in all the stages. That is, the initialization transistors Tr4 in all the stages are simultaneously brought into the non-energized state at a light emission start timing (time t12).

According to such Specific Example 1, the auto-zero signals AZ in all the stages simultaneously transition from the low level to the high level at the light emission start timing (time t12), and the initialization transistors Tr4 in all the stages are brought into the non-energized state. As a result, as illustrated in FIG. 9, the holding potentials of the anodes of the light emitting elements EL become the same in all the stages, and the anode potential fluctuation amounts become the same in all the stages. Therefore, there is no difference in coupling (gate-anode coupling) between the gate of the drive transistor Tr1 and the anode of the light emitting element EL in all the stages, and the gate-source voltages Vgs of the drive transistors Tr1 are also the same in all the stages. As a result, as illustrated in FIG. 10, uniform luminance without a luminance difference (gray difference in FIG. 10) is realized in the pixel array unit 30.

Note that in Specific Example 1, the initialization transistors Tr4 in all the stages are simultaneously brought into the non-energized state at the light emission start timing (time t12), but the present invention is not limited thereto, and the initialization transistors Tr4 in all the stages may be brought into the non-energized state at least at or before the light emission start timing (time t12). However, it is preferable to bring the initialization transistors Tr4 in all stages into the non-energized state within a period from the write start timing (time t11) to the light emission start timing (t12).

Here, the write start timing (time t11) is a timing to start sequentially writing the data signal to each light emitting element EL. The light emission start timing (time t12) is a timing at which each light emitting element EL starts to emit light for each stage. The period from the write start timing (time t11) to the light emission start timing (t12) is, for example, a range from time t11 to time t12.

### Specific Example 2

In Specific Example 2, as illustrated in FIG. 11, in the data writing period, the write scanning signal WS sequentially transitions from the high level to the low level for each pixel row from time t11, and after a lapse of a certain period of time, the write scanning signal WS transitions from the low level to the high level. As a result, the write transistor Tr2 is sequentially brought into the conductive state for each pixel row, and after a lapse of a certain period of time, the write transistor Tr2 is brought into the non-energized state (“WS line sequential operation” in the data writing period in FIG. 11).

In addition, in the light emission period, the light emission control signal DS sequentially transitions from the high level to the low level for each stage from time t12. As a result, the light emission control transistor Tr3 is sequentially brought into the conductive state for each stage (“DS block operation” in the light emission period in FIG. 11).

In addition, in the data writing period, the auto-zero signal AZ sequentially transitions from the low level to the high level for each stage in which the data writing is completed (“AZ block operation” in the data writing period in FIG. 11). As a result, the initialization transistor Tr4 is sequentially brought into the non-conductive state for each stage in which the data writing is completed. That is, the initialization transistors Tr4 in all the stages are brought into the non-energized state at or before the light emission start timing (time t12).

In addition, in an extinction period, the light emission control signal DS sequentially transitions from the low level to the high level for each stage from time t13. As a result, the light emission control transistor Tr3 is sequentially brought into the non-conductive state for each stage (“DS block operation” in the extinction period in FIG. 11).

In addition, in the extinction period, the auto-zero signal AZ sequentially transitions from the high level to the low level for each stage from time t13. As a result, the initialization transistor Tr4 is sequentially brought into the conductive state for each stage. That is, the initialization transistor Tr4 is brought into an energized state for each stage from the extinction start timing (time t13).

According to such Specific Example 2, within the period from the write start timing (time t11) to the light emission start timing (time t12), the auto-zero signal AZ sequentially transitions from the low level to the high level for each stage, and the initialization transistors Tr4 in all the stages are brought into the non-energized state. As a result, the holding potentials of the anodes of the light emitting elements EL become the same in all the stages, and the anode potential fluctuation amounts become the same in all the stages. Therefore, there is no difference in coupling (gate-anode coupling) between the gate of the drive transistor Tr1 and the anode of the light emitting element EL in all the stages, and the gate-source voltages Vgs of the drive transistors Tr1 are also the same in all the stages. As a result, uniform luminance without a luminance difference (see FIG. 10) is realized in the pixel array unit 30. In addition, the degree of freedom of timing design and the like of the auto-zero signal AZ in each stage is improved as compared with a case where the auto-zero signals AZ in the stages are simultaneously brought into the non-energized state.

Note that in Specific Example 2, the initialization transistor Tr4 is brought into the energized state for each stage from the extinction start timing (time t13), but the present invention is not limited thereto, and for example, the initialization transistor Tr4 may be brought into the energized state for each stage after the extinction start timing (time t13). Furthermore, for example, the initialization transistors Tr4 in all the stages may be simultaneously brought into the energized state after the extinction start timing (time t13). However, in the collective operation of the simultaneous driving at or before the extinction end timing, since there is a possibility that a through current occurs in the subsequent stage, it is preferable to perform the driving for each stage as described above, or it is preferable to perform the collective operation of the simultaneous driving after the extinction end timing. Here, the extinction start timing (time t13) is a timing at which each light emitting element EL starts to be sequentially extinguished for each stage. In addition, the extinction end timing is a timing at which each light emitting element EL is sequentially extinguished for each stage.

In addition, in Specific Example 2, the auto-zero signal AZ sequentially transitions from the low level to the high level for each stage in the data writing period, but the present invention is not limited thereto. For example, the auto-zero signal AZ may sequentially transition from the low level to the high level for each pixel row in accordance with the write scanning signal WS.

### 1-5. Actions and Effects

As described above, according to the present embodiment, the display device 10 includes the plurality of signal lines 34 extending along a first direction (for example, the column direction), the plurality of control lines (for example, the scanning line 31, the first drive line 32, and the second drive line 33) extending along a second direction (for example, the row direction) different from the first direction, the plurality of pixels 20, and the drive unit (for example, a part or all of the peripheral circuit unit 30A) that drives each pixel 20, in which each of the plurality of pixels 20 includes the light emitting element EL, the capacitor (for example, the holding capacitor C1), the write transistor Tr2 that causes a voltage corresponding to a pixel signal supplied from the corresponding signal line 34 among the plurality of signal lines 34 to be accumulated in the capacitor, the drive transistor Tr1 that supplies a current corresponding to the voltage accumulated in the capacitor to the light emitting element EL, the light emission control transistor Tr3 that controls whether or not to supply the current corresponding to the voltage accumulated in the capacitor from the drive transistor Tr1 to the light emitting element EL, and the initialization transistor Tr4 in which one of a source node and a drain node is provided so as to be connectable to the anode of the light emitting element EL and the other of the source node and the drain node is provided so as to be connectable to the cathode of the light emitting element EL, and the drive unit turns off the initialization transistors Tr4 provided in all of the plurality of pixels 20 when or before the light emission control transistors Tr3 provided in the pixels 20 that simultaneously emit light among the plurality of pixels 20 are turned on. As a result, the initialization transistors Tr4 provided in all of the plurality of pixels 20 are turned off at or before the timing at which the light emission control transistors Tr3 provided in the pixels 20 that simultaneously emit light among the plurality of pixels 20 are turned on, so that the holding potential (voltage) of the anode of the light emitting element EL for each pixel 20 becomes equal in each predetermined region (for example, each stage). Therefore, since the luminance difference of the pixel array unit 30 can be suppressed, the image quality can be improved.

In addition, the drive unit may turn off the initialization transistors Tr4 provided in all of the plurality of pixels 20 within a period from a timing (for example, time t11) at which the write transistors Tr2 provided in the pixels 20 that simultaneously emit light among the plurality of pixels 20 are turned on to a timing (for example, time t12) at which the light emission control transistors Tr3 provided in the pixels 20 that simultaneously emit light among the plurality of pixels 20 are turned on. As a result, the luminance difference of the pixel array unit 30 can be reliably suppressed, so that the image quality can be reliably improved.

In addition, the drive unit may simultaneously turn off the initialization transistors Tr4 provided in all of the plurality of pixels 20. As a result, the control of the initialization transistor Tr4 for each pixel 20 can be simplified.

In addition, the drive unit may simultaneously turn off the initialization transistors Tr4 provided in all of the plurality of pixels 20 at the timing (for example, time t12) at which the light emission control transistors Tr3 provided in the pixels 20 that simultaneously emit light among the plurality of pixels 20 are turned on. As a result, the control of the initialization transistor Tr4 for each pixel 20 can be simplified, and in addition, the driving of the light emitting element EL for each pixel 20 can be permitted at an appropriate timing.

In addition, the drive unit may turn off the initialization transistors Tr4 provided in all of the plurality of pixels 20 by repeating simultaneous turning off of the initialization transistors Tr4 provided in the pixels 20 that simultaneously emit light among the plurality of pixels 20 at or before the timing (for example, time t12) at which the light emission control transistors Tr3 provided in the pixels 20 that simultaneously emit light among the plurality of pixels 20 are turned on, for each predetermined region (for example, stage) defined by the pixels 20 that simultaneously emit light among the plurality of pixels 20. As a result, the driving of the light emitting element EL for each pixel 20 can be permitted at an appropriate timing.

In addition, the drive unit may turn on the initialization transistors Tr4 provided in all of the plurality of pixels 20 at or after the timing (for example, time t13) at which the light emission control transistors Tr3 provided in the pixels 20 that simultaneously emit light among the plurality of pixels 20 are turned off. As a result, it is possible to suppress the occurrence of a phenomenon that affects the image quality in a turn-off period, so that the image quality can be improved.

In addition, the drive unit may turn on the initialization transistors Tr4 provided in all of the plurality of pixels 20 by repeating simultaneous turning on of the initialization transistors Tr4 provided in the pixels 20 that simultaneously emit light among the plurality of pixels 20 at or after the timing (for example, time t13) at which the light emission control transistors Tr3 provided in the pixels 20 that simultaneously emit light among the plurality of pixels 20 are turned off, for each predetermined region (for example, stage) defined by the pixels 20 that simultaneously emit light among the plurality of pixels 20. As a result, the driving of the light emitting element EL for each pixel 20 can be restricted at an appropriate timing.

In addition, the drive unit may simultaneously turn on the initialization transistors Tr4 provided in all of the plurality of pixels 20 after the timing (for example, time t13) at which the light emission control transistors Tr3 provided in the pixels 20 that simultaneously emit light among the plurality of pixels 20 are turned off. As a result, the control of the initialization transistor Tr4 for each pixel 20 can be simplified, and in addition, the driving of the light emitting element EL for each pixel 20 can be restricted at an appropriate timing.

In addition, the light emitting element EL and the initialization transistor Tr4 are connected to a common power supply (for example, the common power supply line 35). Even in such a case, the image quality can be improved.

In addition, the light emitting element EL and the drive transistor Tr1 may be provided in series, and the initialization transistor Tr4 may be provided in parallel with the light emitting element EL. Even with such a configuration, the image quality can be improved.

In addition, the drive unit may control the light emission control transistors Tr3 provided in all of the plurality of pixels 20 for each predetermined region defined by the pixels 20 that simultaneously emit light among the plurality of pixels 20. As a result, the light emitting element EL for each pixel 20 can be reliably driven for each predetermined region.

### 2. Other Embodiments

The processing according to the above-described embodiments (or modifications) may be performed in various different modes (modifications) other than the above-described embodiments. For example, among the processing described in the above embodiments, all or a part of the processing described as being automatically performed can be manually performed, or all or a part of the processing described as being manually performed can be automatically performed by a known method. In addition, the processing procedure, the specific name, and the information including various data and parameters illustrated in the above-described document or the drawings can be arbitrarily changed unless otherwise specified. For example, the various information illustrated in the drawings are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, the above-described embodiments (or modifications) can be appropriately combined within a range in which the processing contents do not contradict each other. In addition, the effects described in the present specification are merely examples and are not limited, and other effects may be provided.

### 3. Modifications

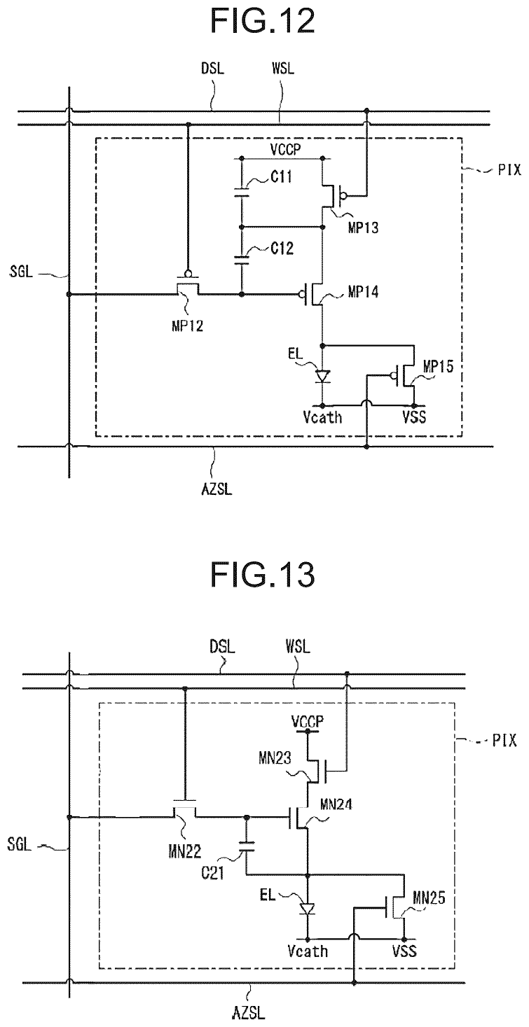

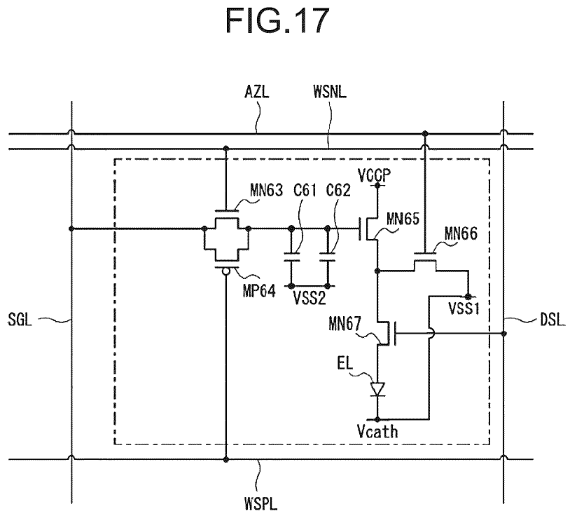

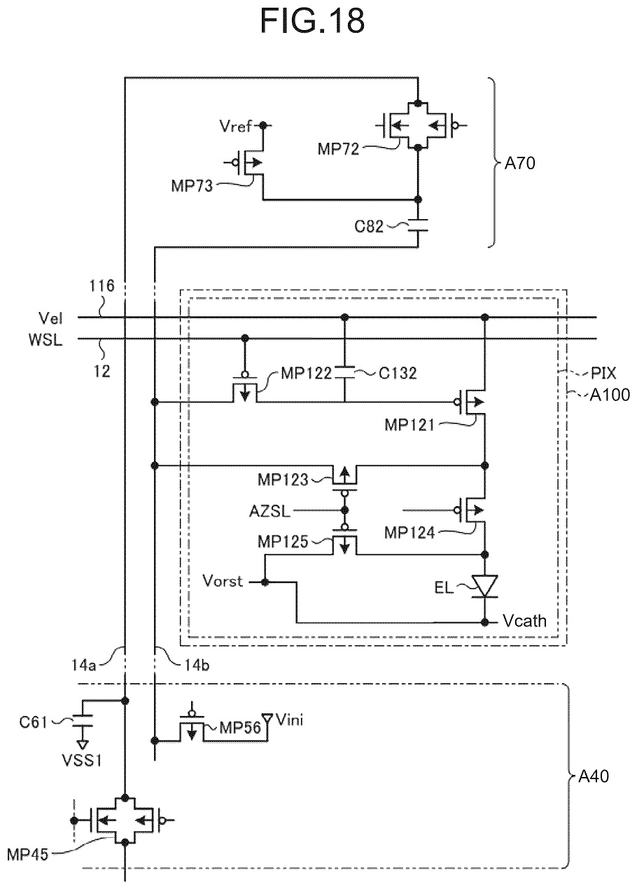

Modifications of the pixel 20 according to the present embodiment will be described with reference to FIGS. 12 to 18. In the examples of FIGS. 12 to 18, configuration examples of a pixel PIX will be described as the modifications of the pixel 20. Note that in FIGS. 12 to 16, a power supply line VSS and the cathode (Vcath) of the light emitting element EL are connected and shared, and in FIG. 17, a power supply line VSS1 and the cathode (Vcath) of the light emitting element EL are connected and shared. In addition, in FIG. 18, a power supply line Vorst and the cathode (Vcath) of the light emitting element EL are connected and shared.

### Specific Example 1

FIG. 12 is a diagram illustrating another configuration example of the pixel PIX. The pixel PIX includes capacitors C11 and C12, transistors MP12 to MP15, and the light emitting element EL. The transistors MP12 to MP15 are P-type MOSFETs. A gate of the transistor MP12 is connected to a control line WSL, a source is connected to a signal line SGL, and a drain is connected to a gate of the transistor MP14 and the capacitor C12. One end of the capacitor C11 is connected to the power supply line VCCP, and the other end is connected to the capacitor C12, a drain of the transistor MP13, and a source of the transistor MP14. One end of the capacitor C12 is connected to the other end of the capacitor C11, the drain of the transistor MP13, and the source of the transistor MP14, and the other end is connected to the drain of the transistor MP12 and the gate of the transistor MP14. A gate of the transistor MP13 is connected to a control line DSL, a source is connected to the power supply line VCCP, and a drain is connected to the source of the transistor MP14, the other end of the capacitor C11, and one end of the capacitor C12. The gate of the transistor MP14 is connected to the drain of the transistor MP12 and the other end of the capacitor C12, the source is connected to the drain of the transistor MP13, the other end of the capacitor C11, and one end of the capacitor C12, and a drain is connected to the anode of the light emitting element EL and a source of the transistor MP15. A gate of the transistor MP15 is connected to a control line AZSL, the source is connected to the drain of the transistor MP14 and the anode of the light emitting element EL, and a drain is connected to the power supply line VSS.

With this configuration, in the pixel PIX, when the transistor MP12 is brought into an on-state, a voltage across the capacitor C12 is set based on a pixel signal supplied from the signal line SGL. The transistor MP13 is turned on and off based on a signal of the control line DSL. The transistor MP14 causes a current corresponding to the voltage across the capacitor C12 to flow through the light emitting element EL in a period in which the transistor MP13 is in the on-state. The light emitting element EL emits light based on the current supplied from the transistor MP14. In this manner, the pixel PIX emits light with luminance corresponding to the pixel signal. The transistor MP15 is turned on and off based on a signal of the control line AZSL. In a period in which the transistor MP15 is in the on-state, the voltage of the anode of the light emitting element EL is initialized by being set to the voltage of the power supply line VSS.

### Specific Example 2

FIG. 13 is a diagram illustrating another configuration example of the pixel PIX. The pixel PIX includes a capacitor C21, transistors MN22 to MN25, and the light emitting element EL. The transistors MN22 to MN25 are N-type MOSFETs. A gate of the transistor MN22 is connected to the control line WSL, a drain is connected to the signal line SGL, and a source is connected to a gate of the transistor MN24 and the capacitor C21. One end of the capacitor C21 is connected to the source of the transistor MN22 and the gate of the transistor MN24, and the other end is connected to a source of the transistor MN24, a drain of the transistor MN25, and the anode of the light emitting element EL. A gate of the transistor MN23 is connected to the control line DSL, a drain is connected to the power supply line VCCP, and a source is connected to a drain of the transistor MN24. The gate of the transistor MN24 is connected to the source of the transistor MN22 and one end of the capacitor C21, the drain is connected to the source of the transistor MN23, and the source is connected to the other end of the capacitor C21, the drain of the transistor MN25, and the anode of the light emitting element EL. A gate of the transistor MN25 is connected to the control line AZSL, the drain is connected to the source of the transistor MN24, the other end of the capacitor C21, and the anode of the light emitting element EL, and a source is connected to the power supply line VSS.

With this configuration, in the pixel PIX, when the transistor MN22 is brought into the on-state, a voltage across the capacitor C21 is set based on the pixel signal supplied from the signal line SGL. The transistor MN23 is turned on and off based on the signal of the control line DSL. The transistor MN24 causes a current corresponding to the voltage across the capacitor C21 to flow through the light emitting element EL in a period in which the transistor MN23 is in the on-state. The light emitting element EL emits light based on the current supplied from the transistor MN24. In this manner, the pixel PIX emits light with luminance corresponding to the pixel signal. The transistor MN25 is turned on and off based on the signal of the control line AZSL. In a period in which the transistor MN25 is in the on-state, the voltage of the anode of the light emitting element EL is initialized by being set to the voltage of the power supply line VSS.

### Specific Example 3

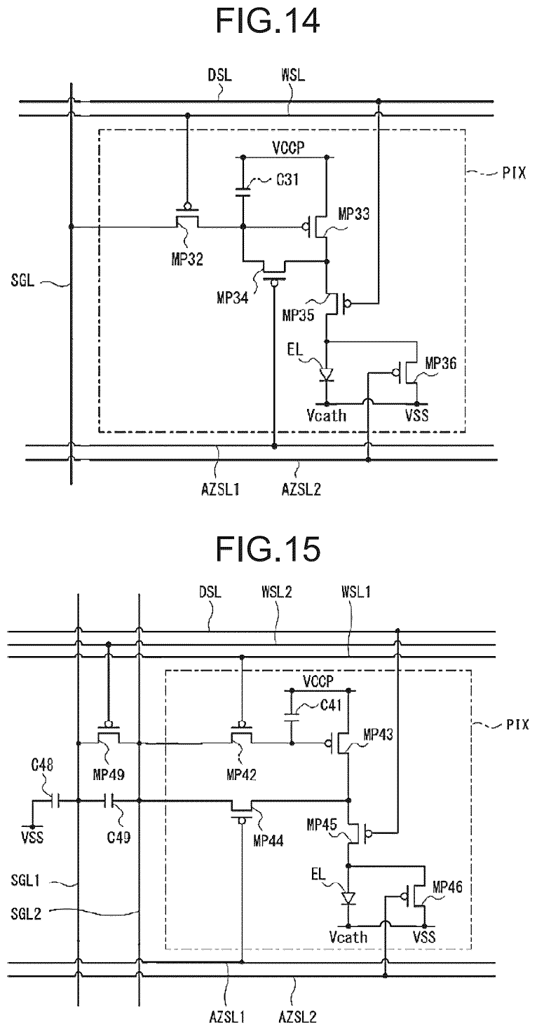

FIG. 14 is a diagram illustrating another configuration example of the pixel PIX. The pixel PIX includes a capacitor C31, transistors MP32 to MP36, and the light emitting element EL. The transistors MP32 to MP36 are P-type MOSFETs. A gate of the transistor MP32 is connected to the control line WSL, a source is connected to the signal line SGL, and a drain is connected to a gate of the transistor MP33, a drain of the transistor MP34, and the capacitor C31. One end of the capacitor C31 is connected to the power supply line VCCP, and the other end is connected to the drain of the transistor MP32, the gate of the transistor MP33, and the drain of the transistor MP34. A gate of the transistor MP34 is connected to a control line AZSL1, a source is connected to a drain of the transistor MP33 and a source of the transistor MP35, and the drain is connected to the drain of the transistor MP32, the gate of the transistor MP33, and the other end of the capacitor C31. A gate of the transistor MP35 is connected to the control line DSL, the source is connected to the drain of the transistor MP33 and the source of the transistor MP34, and a drain is connected to a source of the transistor MP36 and the anode of the light emitting element EL. A gate of the transistor MP36 is connected to a control line AZSL2, the source is connected to the drain of the transistor MP35 and the anode of the light emitting element EL, and a drain is connected to the power supply line VSS.

With this configuration, in the pixel PIX, when the transistor MP32 is brought into the on-state, a voltage across the capacitor C31 is set based on the pixel signal supplied from the signal line SGL. The transistor MP35 is turned on and off based on the signal of the control line DSL. The transistor MP33 causes a current corresponding to the voltage across the capacitor C31 to flow through the light emitting element EL in a period in which the transistor MP35 is in the on-state. The light emitting element EL emits light based on the current supplied from the transistor MP33. In this manner, the pixel PIX emits light with luminance corresponding to the pixel signal. The transistor MP34 is turned on and off based on a signal of the control line AZSL1. The drain and the gate of the transistor MP33 are connected to each other in a period in which the transistor MP34 is in the on-state. The transistor MP36 is turned on and off based on a signal of the control line AZSL2. In a period in which the transistor MP36 is in the on-state, the voltage of the anode of the light emitting element EL is initialized by being set to the voltage of the power supply line VSS.

### Specific Example 4

FIG. 15 is a diagram illustrating another configuration example of the pixel PIX. One end of a capacitor C48 is connected to a signal line SGL1, and the other end is connected to the power supply line VSS. One end of a capacitor C49 is connected to the signal line SGL1, and the other end is connected to a signal line SGL2. A transistor MP49 is a P-type MOSFET, in which a gate is connected to a control line WSL2, a source is connected to the signal line SGL1, and a drain is connected to the signal line SGL2.

The pixel PIX includes a capacitor C41, transistors MP42 to MP46, and the light emitting element EL. The transistors MP42 to MP46 are P-type MOSFETs. A gate of the transistor MP42 is connected to the control line WSL1, a source is connected to the signal line SGL2, and a drain is connected to a gate of the transistor MP43 and the capacitor C41. One end of the capacitor C41 is connected to the power supply line VCCP, and the other end is connected to the drain of the transistor MP42 and the gate of the transistor MP43. The gate of the transistor MP43 is connected to the drain of the transistor MP42 and the other end of the capacitor C41, a source is connected to the power supply line VCCP, and a drain is connected to sources of the transistors MP44 and MP45. A gate of the transistor MP44 is connected to the control line AZSL1, the source is connected to the drain of the transistor MP43 and the source of the transistor MP45, and a drain is connected to the signal line SGL2. A gate of the transistor MP45 is connected to the control line DSL, the source is connected to the drain of the transistor MP43 and the source of the transistor MP44, and a drain is connected to a source of the transistor MP46 and the anode of the light emitting element EL. A gate of the transistor MP46 is connected to the control line AZSL2, the source is connected to the drain of the transistor MP45 and the anode of the light emitting element EL, and a drain is connected to the power supply line VSS.

With this configuration, in the pixel PIX, when the transistor MP42 is brought into the on-state, a voltage across the capacitor C41 is set based on the pixel signal supplied from the signal line SGL1 via the capacitor C49. The transistor MP45 is turned on and off based on the signal of the control line DSL. The transistor MP43 causes a current corresponding to the voltage across the capacitor C41 to flow through the light emitting element EL in a period in which the transistor MP45 is in the on-state. The light emitting element EL emits light based on the current supplied from the transistor MP43. In this manner, the pixel PIX emits light with luminance corresponding to the pixel signal. The transistor MP44 is turned on and off based on the signal of the control line AZSL1. In a period in which the transistor MP44 is in the on-state, the drain of the transistor MP43 and the signal line SGL2 are connected to each other. The transistor MP46 is turned on and off based on the signal of the control line AZSL2. In a period in which the transistor MP46 is in the on-state, the voltage of the anode of the light emitting element EL is initialized by being set to the voltage of the power supply line VSS.

### Specific Example 5

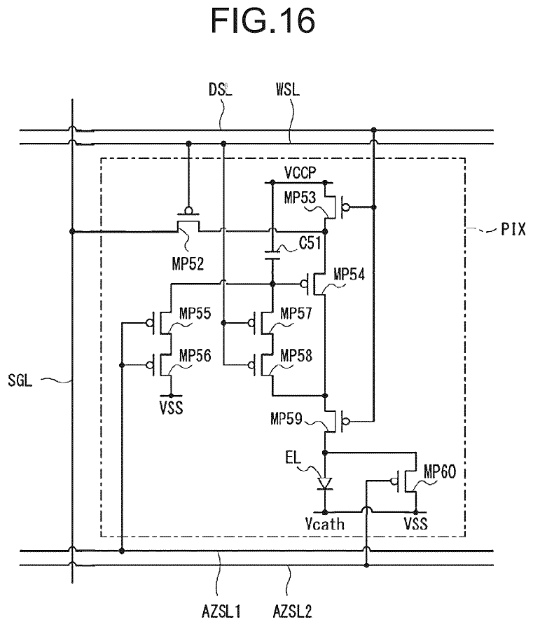

FIG. 16 is a diagram illustrating another configuration example of the pixel PIX. The pixel PIX includes a capacitor C51, transistors MP52 to MP60, and the light emitting element EL. The transistors MP52 to MP60 are P-type MOSFETs. A gate of the transistor MP52 is connected to the control line WSL, a source is connected to the signal line SGL, and a drain is connected to a drain of the transistor MP53 and a source of the transistor MP54. A gate of the transistor MP53 is connected to the control line DSL, a source is connected to the power supply line VCCP, and the drain is connected to the drain of the transistor MP52 and the source of the transistor MP54. A gate of the transistor MP54 is connected to a source of the transistor MP55, a drain of the transistor MP57, and the capacitor C51, the source is connected to the drains of the transistors MP52 and MP53, and a drain is connected to sources of the transistors MP58 and MP59. One end of the capacitor C51 is connected to the power supply line VCCP, and the other end is connected to the gate of the transistor MP54, the source of the transistor MP55, and the drain of the transistor MP57. The capacitor C51 may include two capacitors connected in parallel to each other. A gate of the transistor MP55 is connected to the control line AZSL1, the source is connected to the gate of the transistor MP54, the drain of the transistor MP57, and the other end of the capacitor C51, and a drain is connected to a source of the transistor MP56. A gate of the transistor MP56 is connected to the control line AZSL1, the source is connected to the drain of the transistor MP55, and a drain is connected to the power supply line VSS. A gate of the transistor MP57 is connected to the control line WSL, the drain is connected to the gate of the transistor MP54, the source of the transistor MP55, and the other end of the capacitor C51, and a source is connected to a drain of the transistor MP58. A gate of the transistor MP58 is connected to the control line WSL, the drain is connected to the source of the transistor MP57, and the source is connected to the drain of the transistor MP54 and the source of the transistor MP59. A gate of the transistor MP59 is connected to the control line DSL, the source is connected to the drain of the transistor MP54 and the source of the transistor MP58, and a drain is connected to a source of the transistor MP60 and the anode of the light emitting element EL. A gate of the transistor MP60 is connected to the control line AZSL2, the source is connected to the drain of the transistor MP59 and the anode of the light emitting element EL, and a drain is connected to the power supply line VSS.

With this configuration, in the pixel PIX, when the transistors MP52, MP54, MP58, and MP57 are brought into the on-state, a voltage across the capacitor C51 is set based on the pixel signal supplied from the signal line SGL. The transistors MP53 and MP59 are turned on and off based on the signal of the control line DSL. The transistor MP54 causes a current corresponding to the voltage across the capacitor C51 to flow through the light emitting element EL in a period in which the transistors MP53 and MP59 are in the on-state. The light emitting element EL emits light based on the current supplied from the transistor MP54. In this manner, the pixel PIX emits light with luminance corresponding to the pixel signal. The transistors MP55 and MP56 are turned on and off based on the signal of the control line AZSL1. In a period in which the transistors MP55 and MP56 are in the on-state, the voltage of the gate of the transistor MP54 is initialized by being set to the voltage of the power supply line VSS. The transistor MP60 is turned on and off based on the signal of the control line AZSL2. In a period in which the transistor MP60 is in the on-state, the voltage of the anode of the light emitting element EL is initialized by being set to the voltage of the power supply line VSS.

### Specific Example 6

FIG. 17 is a diagram illustrating another configuration example of the pixel PIX. A signal of a control line WSNL and a signal of a control line WSPL are inverted signals.

The pixel PIX includes capacitors C61 and C62, transistors MN63, MP64, and MN65 to MN67, and the light emitting element EL. The transistors MN63 and MN65 to MN67 are N-type MOSFETs, and the transistor MP64 is a P-type MOSFET. A gate of the transistor MN63 is connected to the control line WSNL, a drain is connected to the signal line SGL and a source of the transistor MP64, and a source is connected to a drain of the transistor MP64, the capacitors C61 and C62, and a gate of the transistor MN65. A gate of the transistor MP64 is connected to the control line WSPL, the source is connected to the signal line SGL and the drain of the transistor MN63, and the drain is connected to the source of the transistor MN63, the capacitors C61 and C62, and the gate of the transistor MN65. The capacitor C61 is configured using, for example, a metal oxide metal (MOM) capacitor, in which one end is connected to the source of the transistor MN63, the drain of the transistor MP64, the capacitor C62, and the gate of the transistor MN65, and the other end is connected to a power supply line VSS2. Note that the capacitor C61 may be configured using, for example, a MOS capacitor or a metal insulator metal (MIM) capacitor. The capacitor C62 is configured using, for example, a MOS capacitor, in which one end is connected to the source of the transistor MN63, the drain of the transistor MP64, one end of the capacitor C61, and the gate of the transistor MN65, and the other end is connected to the power supply line VSS2. Note that the capacitor C62 may be configured using, for example, an MOM capacitor or an MIM capacitor. The gate of the transistor MN65 is connected to the source of the transistor MN63, the drain of the transistor MP64, and one end of each of the capacitors C61 and C62, a drain is connected to the power supply line VCCP, and a source is connected to drains of the transistors MN66 and MN67. A gate of the transistor MN66 is connected to a control line AZL, the drain is connected to the source of the transistor MN65 and the drain of the transistor MN67, and a source is connected to the power supply line VSS1. A gate of the transistor MN67 is connected to the control line DSL, the drain is connected to the source of the transistor MN65 and the drain of the transistor MN66, and a source is connected to the anode of the light emitting element EL.

With this configuration, in the pixel PIX, when at least one of the transistors MN63 and MP64 is brought into the on-state, a voltage across each of the capacitors C61 and C62 is set based on the pixel signal supplied from the signal line SGL. The transistor MN67 is turned on and off based on the signal of the control line DSL. The transistor MN65 causes a current corresponding to the voltage across each of the capacitors C61 and C62 to flow through the light emitting element EL in a period in which the transistor MN67 is in the on-state. The light emitting element EL emits light based on the current supplied from the transistor MP65. In this manner, the pixel PIX emits light with luminance corresponding to the pixel signal. The transistor MN66 may be turned on and off based on the signal of the control line AZL. In addition, the transistor MN66 may function as a resistance element having a resistance value corresponding to the signal of the control line AZL. In this case, the transistor MN65 and the transistor MN66 constitute a so-called source follower circuit.

### Specific Example 7

FIG. 18 is a diagram illustrating another configuration example of the pixel PIX. A plurality of the pixels PIX are provided in a matrix in a display area A100, and the display area A100 is provided between a first control unit A40 and a second control unit A70.

The first control unit 40A includes a transmission gate MP45, a transistor MP56, and a capacitor C61. The transistor MP56 is a P-type MOSFET. A pixel signal is supplied to an input end of the transmission gate MP45, and an output end of the transmission gate MP45 is connected to one end of a signal line 14a. One end of the capacitor C61 is connected to the signal line 14a, and the other end is connected to the power supply line VSS1. A gate of the transistor MP56 is connected to a control line Gini, a source is connected to a signal line 14b, and a drain is connected to a power supply line Vini.

The second control unit A70 includes a transmission gate MP72, a transistor MP73, and a capacitor C82. The transistor MP73 is a P-type MOSFET. An input end of the transmission gate MP72 is connected to the other end of the signal line 14a, and an output end is connected to a source of the transistor MP73 and one end of the capacitor C82. A gate of the transistor MP73 is connected to a control line Gref, the source is connected to the output end of the transmission gate MP72 and one end of the capacitor C82, and a drain is connected to a power supply line Vref. One end of the capacitor C82 is connected to the output end of the transmission gate MP72 and the source of the transistor MP73, and the other end is connected to one end of the signal line 14b.

The pixel PIX includes a capacitor C132, transistors MP121 to MP125, and the light emitting element EL. The transistors MP121 to MP125 are P-type MOSFETs. A gate of the transistor MP122 is connected to a control line 12, a source is connected to the signal line 14b, and a drain is connected to a gate of the transistor MP121 and the capacitor C132. One end of the capacitor C132 is connected to a power supply line 116, and the other end is connected to the drain of the transistor MP122 and the gate of the transistor MP121. The gate of the transistor MP121 is connected to the drain of the transistor MP122 and the other end of the capacitor C132, a source is connected to the power supply line 116, and a drain is connected to sources of the transistors MP123 and MP124. A gate of the transistor MP123 is connected to a control line Gcmp, the source is connected to the drain of the transistor MP121 and the source of the transistor MP124, and a drain is connected to the signal line 14b. A gate of the transistor MP124 is connected to a control line Gel, the source is connected to the drain of the transistor MP121 and the source of the transistor MP123, and a drain is connected to a source of the transistor MP125 and the anode of the light emitting element EL. A gate of the transistor MP125 is connected to the control line Gcmp, the source is connected to the drain of the transistor MP124 and the anode of the light emitting element EL, and a drain is connected to the power supply line Vorst.

With this configuration, in the pixel PIX, when the transistor MP122 is brought into the on-state, a voltage across the capacitor C132 is set based on the pixel signal supplied via the transmission gate MP45, the signal line 14a, the transmission gate MP72, the capacitor C82, and the signal line 14b. The transistor MP124 is turned on and off based on a signal of the control line Gel. The transistor MP121 causes a current corresponding to the voltage across the capacitor C132 to flow through the light emitting element EL in a period in which the transistor MP124 is in the on-state. The light emitting element EL emits light based on the current supplied from the transistor MP121. In this manner, the pixel PIX emits light with luminance corresponding to the pixel signal. The transistors MP123 and MP125 are turned on and off based on a signal of the control line Gcmp. In a period in which the transistor MP123 is in the on-state, the drain of the transistor MP121 and the source of the transistor MP124 are connected to the signal line 14b. In a period in which the transistor MP125 is in the on-state, the voltage of the anode of the light emitting element EL is initialized by being set to the voltage of the power supply line Vorst. In addition, the transistor MP56 is turned on and off based on a signal of the control line Gini, and the transistor MP73 is turned on and off based on a signal of the control line Gref. When the transistor MP56 is brought into the on-state, the signal line 14b is initialized by being set to the voltage of the power supply line Vini. When the transistor MP73 is brought into the on-state, one end of the capacitor C82 is initialized by being set to the voltage of the power supply line Vref.

### 4. Application Example

The display device 10 according to the embodiment described above can be used as a display unit of an electronic apparatus in any field that displays, as an image or a video, a video signal input to the electronic apparatus or a video signal generated in the electronic apparatus. For example, the display device 10 according to the embodiment can be used as a display unit of a mobile terminal device such as a smartphone or a mobile phone, a digital still camera, a head mounted display, a see-through head mounted display, a television device, a notebook personal computer, a video camera, an electronic book, a game machine, or the like.

Note that, the display device according to the embodiment may include a module-shaped device having a sealed configuration. The display module may be provided with a circuit unit for inputting and outputting a signal and the like from the outside to a light emitting region, a flexible printed circuit (FPC), and the like.

As specific examples (application examples) of the electronic apparatus using the display device according to the embodiment, a smartphone, a digital still camera, a head mounted display, a see-through head mounted display, a television device, and a vehicle will be exemplified below. However, the specific examples exemplified here are merely an example, and the specific examples is not limited to this.

### Specific Example 1

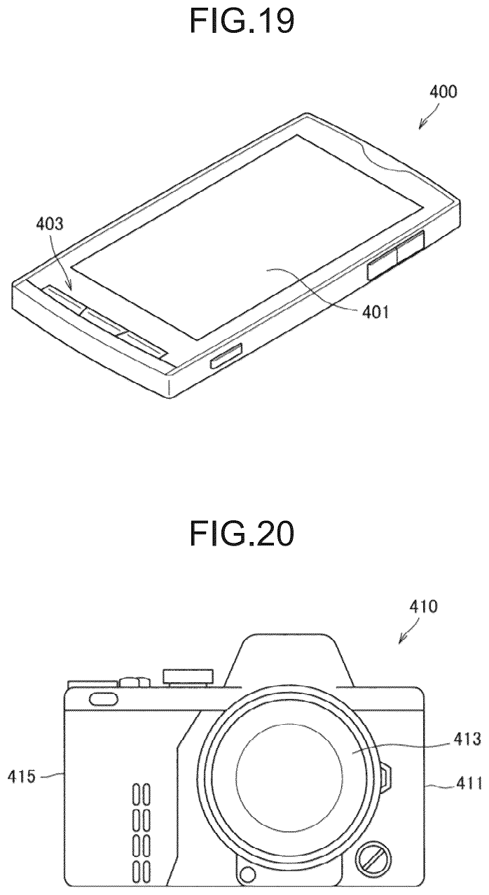

FIG. 19 is a view illustrating an example of an appearance of a smartphone 400. As illustrated in FIG. 19, the smartphone 400 includes a display unit 401 that displays various types of information, and an operation unit 403 including a button or the like that accepts an operation input by a user. The display unit 401 is configured by the display device 10 according to the embodiment.

### Specific Example 2

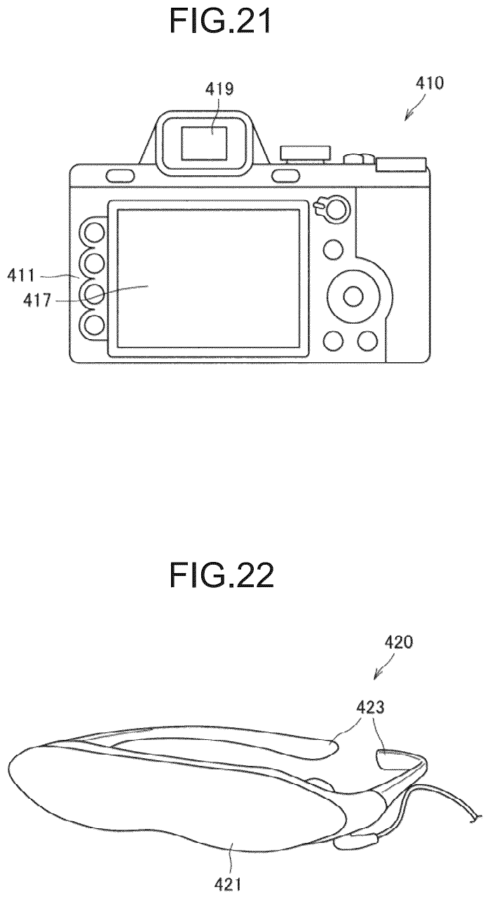

FIGS. 20 and 21 are views each illustrating an example of an appearance of a digital still camera 410. FIG. 20 is a front view of the digital still camera 410, and FIG. 21 is a rear view of the digital still camera 410. As illustrated in FIGS. 20 and 21, the digital still camera 410 is, for example, of a lens interchangeable single lens reflex type, and includes an interchangeable imaging lens unit (interchangeable lens) 413 at substantially the center of the front of a camera body portion (camera body) 411, and a grip portion 415 to be held by a photographer on the front left side.

A monitor 417 is provided at a position shifted to the left side from the center of a back surface of the camera body 411. An electronic viewfinder (eyepiece window) 419 is provided above the monitor 417. By looking into the electronic viewfinder 419, the photographer can determine the composition by visually recognizing an optical image of a subject guided from the imaging lens unit 413. Both or one of the monitor 417 and the electronic viewfinder 419 is configured by the display device 10 according to the embodiment.

### Specific Example 3

FIG. 22 is a view illustrating an example of an appearance of a head mounted display 420. As illustrated in FIG. 22, the head mounted display 420 includes, for example, ear hooking portions 423 to be worn on the user's head at both sides of a glasses-shaped display unit 421. The display unit 421 is configured by the display device 10 according to the embodiment.

### Specific Example 4

FIG. 23 is a view illustrating an example of an appearance of a see-through head mounted display 430. As illustrated in FIG. 23, the see-through head mounted display 430 includes a main body 431, an arm 433, and a lens barrel 435. The main body 431 is connected to the arm 433 and glasses 437. Specifically, an end portion of the main body 431 in the long side direction is coupled to the arm 433, and one side of a side surface of the main body 431 is coupled to the glasses 437 via a connecting member (not illustrated). Note that, the main body 431 may be directly mounted on the head of a human body.

The main body 431 incorporates a control board and a display unit for controlling the operation of the see-through head mounted display 430. The arm 433 connects the main body 431 and the lens barrel 435 to each other and supports the lens barrel 435. Specifically, the arm 433 is coupled to the end portion of the main body 431 and an end portion of the lens barrel 435, and fixes the lens barrel 435. Further, the arm 433 incorporates a signal line for communicating data related to an image provided from the main body 431 to the lens barrel 435.

The lens barrel 435 projects, through the lens of the glasses 437, image light provided from the main body 431 via the arm 433 toward the eyes of the user wearing the see-through head mounted display 430. In the see-through head mounted display 430, the display unit of the main body 431 is configured by the display device 10 according to the embodiment.

### Specific Example 5

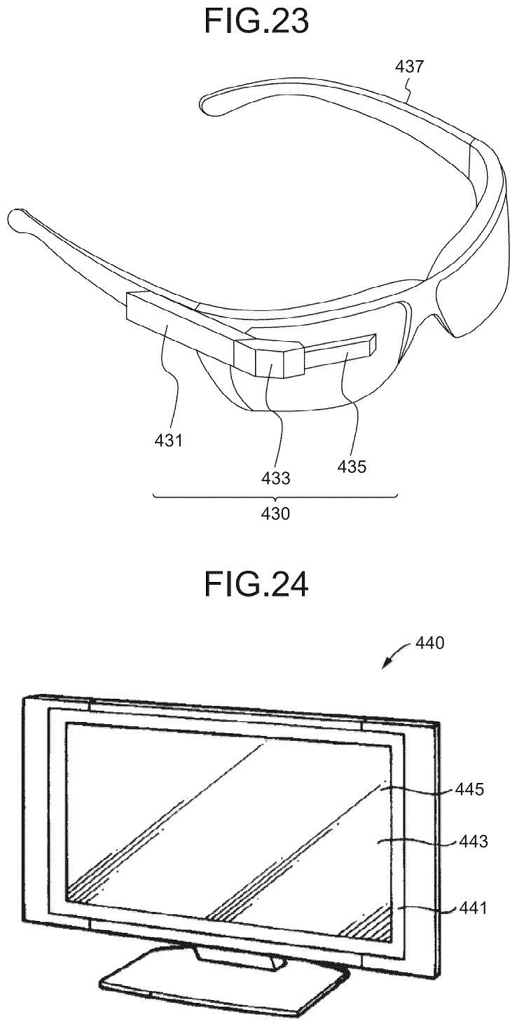

FIG. 24 is a view illustrating an example of an appearance of a television device 440. As illustrated in FIG. 24, the television device 440 includes a video display screen unit 441. The video display screen unit 441 includes, for example, a front panel 443 and a filter glass 445. The video display screen unit 441 is configured by the display device 10 according to the embodiment.

### Specific Example 6

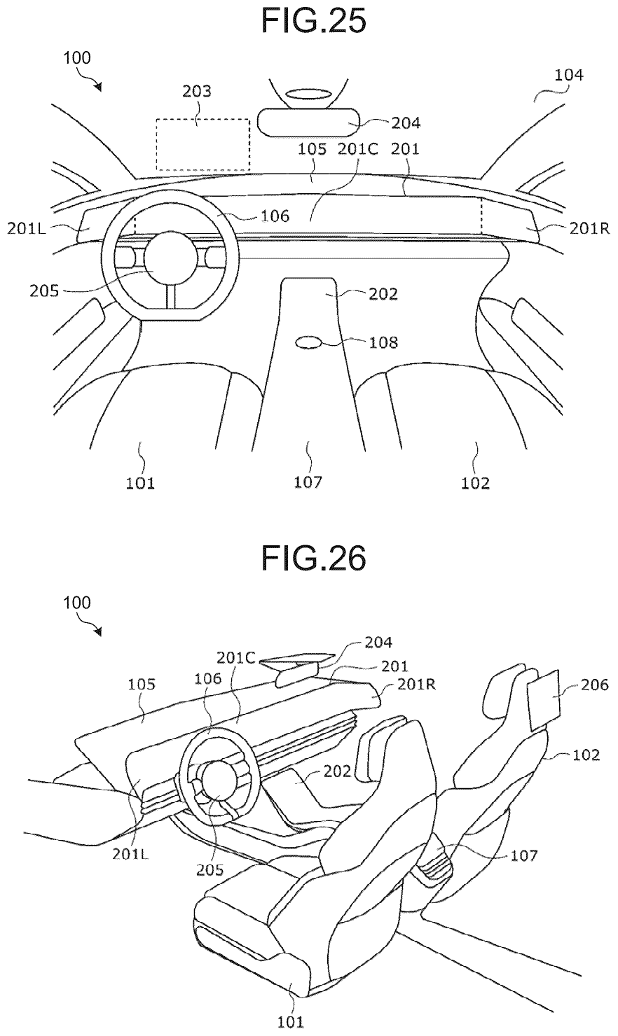

FIGS. 25 and 26 are diagrams each illustrating an internal configuration of a vehicle 100. FIG. 25 illustrates the interior of the vehicle 100 from the rear to the front of the vehicle 100, and FIG. 26 illustrates the interior of the vehicle 100 from the oblique rear to the oblique front of the vehicle 100.

As illustrated in FIGS. 25 and 26, the vehicle 100 includes a center display 201, a console display 202, a head-up display 203, a digital rear mirror 204, a steering wheel display 205, and a rear entertainment display 206. Any or all of these displays 201 to 206 are configured by the display device 10 according to the embodiment.

The center display 201 is disposed on a dashboard 105 at a position facing a driver's seat 101 and a passenger seat 102. FIGS. 25 and 26 illustrate an example of the center display 201 (201C, 201L, 201R) having a horizontally long shape extending from the driver's seat 101 side to the passenger seat 102 side, but the screen size and the arrangement location of the center display 201 are arbitrary. The center display 201 can display information detected by various sensors. As a specific example, the center display 201 can display a captured image captured by an image sensor, a distance image to an obstacle in front of or on a side of the vehicle measured by a ToF sensor, a passenger's body temperature detected by an infrared sensor, and the like. The center display 201 can be used to display, for example, at least one of safety related information, operation related information, a life log, health related information, authentication/identification related information, and entertainment related information.

The safety related information is information such as doze detection, looking-away detection, detection of mischief of a child riding together, whether or not a seat belt is fastened, and detection of leaving of an occupant, and is, for example, information detected by a sensor superimposed on the back side of the center display 201. In the operation related information, a gesture related to an operation of the occupant is detected using the sensor. The detected gesture may include operations of various kinds of equipment in the vehicle 100. For example, operations of air conditioning equipment, a navigation device, an AV device, a lighting device, and the like are detected. The life log includes life logs of all the occupants. For example, the life log includes an action record of each occupant riding in the vehicle. By acquiring and storing the life log, it is possible to check a state of the occupant at the time of an accident. In the health related information, a body temperature of the occupant is detected using a temperature sensor, and a health condition of the occupant is presumed based on the detected body temperature. Alternatively, the health condition of the occupant may be presumed by taking an image of the face of the occupant using an image sensor and presuming the health condition based on the image of the facial expression thus taken. Still alternatively, the health condition of the occupant may be presumed by communicating with the occupant in an automatic voice and presuming the health condition based on an answer of the occupant. The authentication/identification related information includes a keyless entry function of performing face authentication using a sensor, an automatic adjustment function of a sheet height and a position by face identification, and the like. The entertainment related information includes a function of detecting operation information of the AV device by the occupant using the sensor, a function of recognizing the face of the occupant by the sensor and providing content suitable for the occupant by the AV device, and the like.

The console display 202 can be used to display life log information, for example. The console display 202 is disposed near a shift lever 108 of a center console 107 between the driver's seat 101 and the passenger seat 102. The console display 202 can also display information detected by various sensors. In addition, the console display 202 may display an image of the periphery of the vehicle captured by the image sensor, or may display a distance image to an obstacle at the periphery of the vehicle.

The head-up display 203 is virtually displayed behind a windshield 104 in front of the driver's seat 101. The head-up display 203 can be used to display, for example, at least one of safety related information, operation related information, a life log, health related information, authentication/identification related information, and entertainment related information. Since the head-up display 203 is often virtually arranged in front of the driver's seat 101, it is suitable for displaying information directly related to an operation of the vehicle 100 such as the speed of the vehicle 100 and the remaining amount of fuel (battery).

The digital rear mirror 204 can not only display the rear of the vehicle 100 but also display the state of the occupant in the rear seat, and thus can be used to display the life log information, for example, by disposing the sensor so that it is superimposed on the back side of the digital rear mirror 204.

The steering wheel display 205 is disposed near the center of a steering wheel 106 of the vehicle 100. The steering wheel display 205 can be used to display, for example, at least one of safety related information, operation related information, a life log, health related information, authentication/identification related information, and entertainment related information. In particular, since the steering wheel display 205 is located close to the driver's hand, it is suitable for displaying life log information such as the body temperature of the driver, or for displaying information related to the operation of an AV device, an air conditioning unit, and the like.

The rear entertainment display 206 is mounted on the back side of the driver's seat 101 and the passenger seat 102, and is for viewing by the occupant in the rear seat. The rear entertainment display 206 can be used to display, for example, at least one of safety related information, operation related information, a life log, health related information, authentication/identification related information, and entertainment related information. In particular, since the rear entertainment display 206 is located in front of the occupant in the rear seat, information related to the occupant in the back seat is displayed. For example, information related to the operation of the AV device and the air conditioning unit may be displayed, or a result of measuring the body temperature and the like of the occupant in the rear seat by the temperature sensor may be displayed.

As described above, by disposing the sensor so that it is superimposed on the back side of the display, a distance to an object existing in the surroundings can be measured. Optical distance measurement methods are roughly classified into a passive type and an active type. The passive type measures a distance by receiving light from an object without projecting light from the sensor to the object. Examples of the passive type include a lens focus method, a stereo method, and a monocular vision method. The active type measures a distance by projecting light to an object and receiving light from the object by the sensor. Examples of the active type include an optical radar method, an active stereo method, an illuminance difference stereo method, a moiré topography method, and an interference method. The display device 10 according to the embodiment can be applied to any of these types of distance measurement. By using the sensor disposed to be superimposed on the back side of the display device 10 according to the embodiment, the above-described passive or active distance measurement can be performed.

Note that, the electronic apparatus to which the display device 10 according to each embodiment can be applied is not limited to the above examples. The display device 10 according to each embodiment can be applied to a display unit of an electronic apparatus in any field that performs display on the basis of an image signal input from the outside or an image signal generated inside. In other words, the technology according to the present disclosure can be applied to various products. For example, as the vehicle 100 described above, the display device 10 according to each embodiment may be realized as a display unit of any type of mobile body such as an automobile, an electric vehicle, a hybrid electric vehicle, a motorcycle, a bicycle, a personal mobility, an airplane, a drone, a ship, a robot, a construction machine, and an agricultural machine (tractor). Further, for example, the display device 10 according to each embodiment may be applied to a display unit included in an endoscopic surgery system, a microscopic surgery system, or the like.

Although the embodiments, the modifications, the application examples, and the like of the present disclosure have been described in detail with reference to the accompanying drawings, the technical scope of the present disclosure is not limited to such examples. It is obvious that a person having ordinary knowledge in the technical field of the present disclosure can conceive of various changes or modifications within the scope of the technical idea described in the claims, and it is naturally understood that these also belong to the technical scope of the present disclosure.

### 5. Appendix

Note that the present technology can also have the following configurations.

(1)

A display device comprising:
a plurality of signal lines extending along a first direction;
a plurality of control lines extending along a second direction different from the first direction;
a plurality of pixels; and
a drive unit that drives the plurality of pixels, wherein
each of the plurality of pixels includes
a light emitting element,
a capacitor,
a write transistor that causes a voltage corresponding to a pixel signal supplied from a corresponding signal line among the plurality of signal lines to be accumulated in the capacitor,
a drive transistor that supplies a current corresponding to the voltage accumulated in the capacitor to the light emitting element,
a light emission control transistor that controls whether or not to supply the current corresponding to the voltage accumulated in the capacitor from the drive transistor to the light emitting element, and
an initialization transistor in which one of a source node and a drain node is provided to be connectable to an anode of the light emitting element and the other of the source node and the drain node is provided to be connectable to a cathode of the light emitting element, and
the drive unit turns off the initialization transistors provided in all of the plurality of pixels at or before a timing at which the light emission control transistors provided in pixels that simultaneously emit light among the plurality of pixels are turned on.
   (2)

The display device according to (1), wherein
the drive unit turns off the initialization transistors provided in all of the plurality of pixels within a period from a timing at which the write transistors provided in the pixels that simultaneously emit light among the plurality of pixels are turned on to the timing at which the light emission control transistors provided in the pixels that simultaneously emit light among the plurality of pixels are turned on.
   (3)

The display device according to (1) or (2), wherein
the drive unit simultaneously turns off the initialization transistors provided in all of the plurality of pixels.
   (4)

The display device according to (3), wherein
the drive unit simultaneously turns off the initialization transistors provided in all of the plurality of pixels at the timing at which the light emission control transistors provided in the pixels that simultaneously emit light among the plurality of pixels are turned on.
   (5)

The display device according to (1), wherein
the drive unit turns off the initialization transistors provided in all of the plurality of pixels by repeating simultaneous turning off of the initialization transistors provided in the pixels that simultaneously emit light among the plurality of pixels, for each predetermined region defined by the pixels that simultaneously emit light among the plurality of pixels, at or before the timing at which the light emission control transistors provided in the pixels that simultaneously emit light among the plurality of pixels are turned on.
   (6)

The display device according to any one of (1) to (5), wherein
the drive unit turns on the initialization transistors provided in all of the plurality of pixels at or after a timing at which the light emission control transistors provided in the pixels that simultaneously emit light among the plurality of pixels are turned off.
   (7)

The display device according to (6), wherein
the drive unit turns on the initialization transistors provided in all of the plurality of pixels by repeating simultaneous turning on of the initialization transistors provided in the pixels that simultaneously emit light among the plurality of pixels, for each predetermined region defined by the pixels that simultaneously emit light among the plurality of pixels, at or after the timing at which the light emission control transistors provided in the pixels that simultaneously emit light among the plurality of pixels are turned off.
   (8)

The display device according to (6), wherein
the drive unit simultaneously turns on the initialization transistors provided in all of the plurality of pixels after the timing at which the light emission control transistors provided in the pixels that simultaneously emit light among the plurality of pixels are turned off.
   (9)

The display device according to any one of (1) to (8), wherein
the light emitting element and the initialization transistor are connected to a common power supply.
   (10)

The display device according to (9), wherein
the light emitting element and the drive transistor are provided in series, and
the initialization transistor is provided in parallel with the light emitting element.
   (11)

The display device according to any one of (1) to (10), wherein
the drive unit controls the light emission control transistors provided in all of the plurality of pixels for each predetermined region defined by the pixels that simultaneously emit light among the plurality of pixels.
   (12)

An electronic apparatus comprising
a display device, wherein
the display device includes
a plurality of signal lines extending along a first direction,
a plurality of control lines extending along a second direction different from the first direction,
a plurality of pixels, and
a drive unit that drives the plurality of pixels,
each of the plurality of pixels includes
a light emitting element,
a capacitor,
a write transistor that causes a voltage corresponding to a pixel signal supplied from a corresponding signal line among the plurality of signal lines to be accumulated in the capacitor,
a drive transistor that supplies a current corresponding to the voltage accumulated in the capacitor to the light emitting element,
a light emission control transistor that controls whether or not to supply the current corresponding to the voltage accumulated in the capacitor from the drive transistor to the light emitting element, and
an initialization transistor in which one of a source node and a drain node is provided to be connectable to an anode of the light emitting element and the other of the source node and the drain node is provided to be connectable to a cathode of the light emitting element, and
the drive unit turns off the initialization transistors provided in all of the plurality of pixels at or before a timing at which the light emission control transistors provided in pixels that simultaneously emit light among the plurality of pixels are turned on.
   (13)

A driving method of a display device, the display device including
a plurality of signal lines extending along a first direction,
a plurality of control lines extending along a second direction different from the first direction,
a plurality of pixels, and
a drive unit that drives the plurality of pixels,
each of the plurality of pixels including
a light emitting element,
a capacitor,
a write transistor that causes a voltage corresponding to a pixel signal supplied from a corresponding signal line among the plurality of signal lines to be accumulated in the capacitor,
a drive transistor that supplies a current corresponding to the voltage accumulated in the capacitor to the light emitting element,
a light emission control transistor that controls whether or not to supply the current corresponding to the voltage accumulated in the capacitor from the drive transistor to the light emitting element, and
an initialization transistor in which one of a source node and a drain node is provided to be connectable to an anode of the light emitting element and the other of the source node and the drain node is provided to be connectable to a cathode of the light emitting element, the driving method comprising
turning off, by the drive unit, the initialization transistors provided in all of the plurality of pixels at or before a timing at which the light emission control transistors provided in pixels that simultaneously emit light among the plurality of pixels are turned on.
   (14)

An electronic apparatus including the display device according to any one of (1) to (11).

(15)

A driving method of a display device for driving the display device according to any one of (1) to (11).

### REFERENCE SIGNS LIST

10 DISPLAY DEVICE
20 PIXEL
21 DRIVE CIRCUIT UNIT
30 PIXEL ARRAY UNIT
30A PERIPHERAL CIRCUIT UNIT
31 SCANNING LINE
32 FIRST DRIVE LINE
33 SECOND DRIVE LINE
34 SIGNAL LINE
35 COMMON POWER SUPPLY LINE
40 WRITE SCANNING UNIT
50 DRIVE SCANNING UNIT
50A FIRST DRIVE SCANNING UNIT
50B SECOND DRIVE SCANNING UNIT
60 SIGNAL OUTPUT UNIT
70 DISPLAY PANEL
C1 HOLDING CAPACITOR
C2 AUXILIARY CAPACITOR
EL LIGHT EMITTING ELEMENT
Tr1 DRIVE TRANSISTOR
Tr2 WRITE TRANSISTOR
Tr3 LIGHT EMISSION CONTROL TRANSISTOR
Tr4 SWITCHING TRANSISTOR

1. A display device comprising:
a plurality of signal lines extending along a first direction;
a plurality of control lines extending along a second direction different from the first direction;
a plurality of pixels; and
a drive unit that drives the plurality of pixels, wherein
each of the plurality of pixels includes
a light emitting element,
a capacitor,
a write transistor that causes a voltage corresponding to a pixel signal supplied from a corresponding signal line among the plurality of signal lines to be accumulated in the capacitor,
a drive transistor that supplies a current corresponding to the voltage accumulated in the capacitor to the light emitting element,
a light emission control transistor that controls whether or not to supply the current corresponding to the voltage accumulated in the capacitor from the drive transistor to the light emitting element, and
an initialization transistor in which one of a source node and a drain node is provided to be connectable to an anode of the light emitting element and the other of the source node and the drain node is provided to be connectable to a cathode of the light emitting element, and
the drive unit turns off the initialization transistors provided in all of the plurality of pixels at or before a timing at which the light emission control transistors provided in pixels that simultaneously emit light among the plurality of pixels are turned on.

2. The display device according to claim 1, wherein
the drive unit turns off the initialization transistors provided in all of the plurality of pixels within a period from a timing at which the write transistors provided in the pixels that simultaneously emit light among the plurality of pixels are turned on to the timing at which the light emission control transistors provided in the pixels that simultaneously emit light among the plurality of pixels are turned on.

3. The display device according to claim 1, wherein
the drive unit simultaneously turns off the initialization transistors provided in all of the plurality of pixels.

4. The display device according to claim 3, wherein
the drive unit simultaneously turns off the initialization transistors provided in all of the plurality of pixels at the timing at which the light emission control transistors provided in the pixels that simultaneously emit light among the plurality of pixels are turned on.

5. The display device according to claim 1, wherein
the drive unit turns off the initialization transistors provided in all of the plurality of pixels by repeating simultaneous turning off of the initialization transistors provided in the pixels that simultaneously emit light among the plurality of pixels, for each predetermined region defined by the pixels that simultaneously emit light among the plurality of pixels, at or before the timing at which the light emission control transistors provided in the pixels that simultaneously emit light among the plurality of pixels are turned on.

6. The display device according to claim 1, wherein
the drive unit turns on the initialization transistors provided in all of the plurality of pixels at or after a timing at which the light emission control transistors provided in the pixels that simultaneously emit light among the plurality of pixels are turned off.

7. The display device according to claim 6, wherein
the drive unit turns on the initialization transistors provided in all of the plurality of pixels by repeating simultaneous turning on of the initialization transistors provided in the pixels that simultaneously emit light among the plurality of pixels, for each predetermined region defined by the pixels that simultaneously emit light among the plurality of pixels, at or after the timing at which the light emission control transistors provided in the pixels that simultaneously emit light among the plurality of pixels are turned off.

8. The display device according to claim 6, wherein
the drive unit simultaneously turns on the initialization transistors provided in all of the plurality of pixels after the timing at which the light emission control transistors provided in the pixels that simultaneously emit light among the plurality of pixels are turned off.

9. The display device according to claim 1, wherein
the light emitting element and the initialization transistor are connected to a common power supply.

10. The display device according to claim 9, wherein
the light emitting element and the drive transistor are provided in series, and
the initialization transistor is provided in parallel with the light emitting element.

11. The display device according to claim 1, wherein
the drive unit controls the light emission control transistors provided in all of the plurality of pixels for each predetermined region defined by the pixels that simultaneously emit light among the plurality of pixels.

12. An electronic apparatus comprising
a display device, wherein
the display device includes
a plurality of signal lines extending along a first direction,
a plurality of control lines extending along a second direction different from the first direction,
a plurality of pixels, and
a drive unit that drives the plurality of pixels,
each of the plurality of pixels includes
a light emitting element,
a capacitor,
a write transistor that causes a voltage corresponding to a pixel signal supplied from a corresponding signal line among the plurality of signal lines to be accumulated in the capacitor,
a drive transistor that supplies a current corresponding to the voltage accumulated in the capacitor to the light emitting element,
a light emission control transistor that controls whether or not to supply the current corresponding to the voltage accumulated in the capacitor from the drive transistor to the light emitting element, and
an initialization transistor in which one of a source node and a drain node is provided to be connectable to an anode of the light emitting element and the other of the source node and the drain node is provided to be connectable to a cathode of the light emitting element, and
the drive unit turns off the initialization transistors provided in all of the plurality of pixels at or before a timing at which the light emission control transistors provided in pixels that simultaneously emit light among the plurality of pixels are turned on.

13. A driving method of a display device, the display device including
a plurality of signal lines extending along a first direction,
a plurality of control lines extending along a second direction different from the first direction,
a plurality of pixels, and
a drive unit that drives the plurality of pixels,
each of the plurality of pixels including
a light emitting element,
a capacitor,
a write transistor that causes a voltage corresponding to a pixel signal supplied from a corresponding signal line among the plurality of signal lines to be accumulated in the capacitor,
a drive transistor that supplies a current corresponding to the voltage accumulated in the capacitor to the light emitting element,
a light emission control transistor that controls whether or not to supply the current corresponding to the voltage accumulated in the capacitor from the drive transistor to the light emitting element, and
an initialization transistor in which one of a source node and a drain node is provided to be connectable to an anode of the light emitting element and the other of the source node and the drain node is provided to be connectable to a cathode of the light emitting element, the driving method comprising
turning off, by the drive unit, the initialization transistors provided in all of the plurality of pixels at or before a timing at which the light emission control transistors provided in pixels that simultaneously emit light among the plurality of pixels are turned on.
